(19) United States
(12) Patent Application Publication
(10) Pub. No.: US 2019/0342112 A1
(43) Pub. Date: Nov. 7, 2019

(54) METHOD AND APPARATUS FOR CONTROLLING SMART DEVICE

(71) Applicant: Alibaba Group Holding Limited, Grand Cayman (KY)

(72) Inventors: Yanjun LI, Zhejiang (CN); Yang Gu, Zhejiang (CN); Fei FENG, Zhejiang (CN); Yuzhou Huang, Zhejiang (CN); Jing TAN, Zhejiang (CN)

(21) Appl. No.: 16/517,213

(22) Filed: Jul. 19, 2019

Related U.S. Application Data
(63) Continuation of application No. PCT/CN2018/072053, filed on Jul. 10, 2018.

(30) Foreign Application Priority Data
Jan. 20, 2017 (CN) 201710041288.0

(51) Int. Cl. H04L 12/28; G06Q 50/12; H04L 29/06

(52) U.S. Cl. CPC H04L 12/282; G06Q 50/12; H04L 63/0807; H04L 12/2821; H04L 12/281

(57) ABSTRACT

Control servers of various IoT service providers are pre-registered with a gateway platform, so that a client terminal is decoupled from the control servers of the IoT service providers and the client terminal becomes a universal terminal corresponding to the gateway platform. The control servers of the IoT service providers and controllers installed by the IoT service providers no longer uniquely correspond to the client terminal, and a user may send a control request to control servers of different IoT service providers via the client terminal and the gateway platform. Thus, if the user replaces a damaged controller with a controller of another IoT service provider or uses controllers of more than two IoT service providers at the same time, the user does not need to change a new client terminal or use more than two client terminals at the same time.

### CROSS REFERENCE TO RELATED PATENT APPLICATIONS

This application claims priority to and is a continuation of PCT Patent Application No. PCT/CN2018/072053, filed on 10 Jan. 2018 and entitled “METHOD AND APPARATUS FOR CONTROLLING SMART DEVICE,” which claims priority to Chinese Patent Application No. 201710041288.0, filed on 20 Jan. 2017 and entitled “METHOD AND APPARATUS FOR CONTROLLING SMART DEVICE,” which are incorporated herein by reference in their entirety.

### TECHNICAL FIELD

The present disclosure relates to the field of IoT (Internet of Things) technologies, and, more particularly, to methods and apparatuses for controlling a smart device.

### BACKGROUND

With the boom of the IoT technologies, it has become a new trend of development to take a certain space (e.g., in a house or hotel) as a platform, and transform the space by an IoT service provider using an integrated wiring technology, a network communication technology, an automatic control technology, an audio and video technology, and so on, to intelligentize devices in the space into smart devices that may be remotely controlled by users (such as residents of a house or managers and guests of a hotel) in real time via the Internet. For example, a user may use a mobile phone to control, via the Internet, a door lock of the house to unlock automatically, a pendant in a kitchen of the house to light automatically, an air conditioner in a bedroom of the house to be adjusted to a specific temperature, and so on.

FIG. 1 is a schematic diagram of an existing control method for a smart device. An IoT service provider 102 transforms a space by installing a controller 104 of a smart device 106 (such as a smart door lock controller, a smart air conditioner controller, and a TV box) in the space. Moreover, a user 108 further needs to use a client terminal 110 provided by the IoT service provider 102. As such, the user 108 uses the client terminal 110 to send a control request to a control server of the IoT service provider, the control server determines, according to the control request, a smart device to be controlled by the user 108 and then sends a control instruction to a controller 104 corresponding to the smart device 106, and the controller 104 implements the control over the smart device 106.

However, the control server of the IoT service provider, the controller installed by the IoT service provider, and the client terminal provided by the IoT service provider are in unique correspondence, controllers and client terminals installed and provided by different IoT service providers are also different, and the client terminal provided by a certain IoT service provider only supports sending a control request to a control server of the IoT service provider. Therefore, if a user replaces a damaged controller with a controller of another IoT service provider or uses controllers of more than two IoT service providers at the same time, the user also has to change to a new client terminal or use more than two client terminals at the same time, which reduces the convenience for the user to use the IoT to control a smart device.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide a method and apparatus for controlling smart device to improve the convenience for a user to use the IoT to control the smart device.

In order to solve the foregoing technical problem, the example embodiments of the present disclosure are implemented as follows.

A control method for a smart device, according to the example embodiments of the present disclosure, is applied to a gateway platform and comprises:

receiving a control request sent by a client terminal, wherein a device ID of a to-be-controlled smart device and first device execution information are carried in the control request;

determining, according to the device ID, a control server corresponding to the device ID from control servers establishing a cooperative relationship with the gateway platform, wherein mapping relationships between device IDs of different smart devices and server IDs of control servers that control the smart devices are stored in the gateway platform; and

forwarding the control request to the determined control server, so that the determined control server generates a control instruction according to the first device execution information and sends the control instruction to a controller corresponding to the device ID so that the controller controls the smart device.

A control method for a smart device, according to an example embodiment of the present disclosure, is applied to a gateway platform and comprises:

receiving control information input by a user, the control information including a device ID of a to-be-controlled smart device and first device execution information;

generating, according to the control information, a control request carrying the control information; and

sending the control request to the gateway platform, so that the gateway platform determines, according to the device ID, a control server corresponding to the device ID from control servers establishing a cooperative relationship with the gateway platform, and forwards the control request to the determined control server to cause the determined control server to generate a control instruction and send the control instruction to a corresponding controller to control the corresponding smart device.

A control method for a smart device, according to an example embodiment of the present disclosure, is applied to a gateway platform and comprises:

receiving a control request sent by a user, wherein a room ID allocated to the user, a device ID of a to-be-controlled smart device, and first device execution information are carried in the control request;

determining, according to the room ID and a user ID of the user, a control permission of the user to control a smart device in a room corresponding to the room ID;

determining, according to the device ID, a control server corresponding to the device ID from control servers establishing a cooperative relationship with the gateway platform when the determined control permission allows control over the to-be-controlled smart device; and

forwarding the control request to the determined control server, so that the determined control server generates a control instruction according to the first device execution information and sends the control instruction to a controller corresponding to the device ID to cause the controller to control the smart device.

A control method for a smart device according to an example embodiment of the present disclosure comprises:

receiving check-in confirmation information sent by a hotel management system, wherein the check-in confirmation information is generated by the hotel management system after a user is checked in, and includes a room ID allocated by the hotel management system to the user;

acquiring, according to the check-in confirmation information, a control page for the user to control a smart device in a room corresponding to the room ID; and

sending, based on the control page, a control request to a network platform, wherein the room ID allocated to the user, a device ID of a to-be-controlled smart device, and first device execution information are carried in the control request, so that the network platform controls the to-be-controlled smart device according to the control request.

A control method for a smart device according to an example embodiment of the present disclosure comprises:

receiving a control request sent by a hotel management system, wherein a device ID of a to-be-controlled smart device and first device execution information are carried in the control request;

determining, according to the device ID, a control server corresponding to the device ID from control servers establishing a cooperative relationship with the gateway platform; and

forwarding the control request to the determined control server, so that the determined control server generates a control instruction according to the first device execution information and sends the control instruction to a controller corresponding to the device ID to cause the controller to control the smart device.

A control apparatus for a smart device according to an example embodiment of the present disclosure comprises:

a receiving module configured to receive a control request sent by a client terminal, wherein a device ID of a to-be-controlled smart device and first device execution information are carried in the control request;

a determining module configured to determine, according to the device ID, a control server corresponding to the device ID from control servers establishing a cooperative relationship with the control apparatus, wherein mapping relationships between device IDs of different smart devices and server IDs of control servers that control the smart devices are stored in the control apparatus; and

a forwarding module configured to forward the control request to the determined control server, so that the determined control server generates a control instruction according to the first device execution information and sends the control instruction to a controller corresponding to the device ID to cause the controller to control the smart device.

A control apparatus for a smart device according to an example embodiment of the present disclosure comprises:

a receiving module configured to receive control information input by a user, the control information including a device ID of a to-be-controlled smart device and first device execution information;

a generating module configured to generate, according to the control information, a control request carrying the control information; and

a sending module configured to send the control request to a gateway platform, so that the gateway platform determines, according to the device ID, a control server corresponding to the device ID from control servers establishing a cooperative relationship with the gateway platform, and forwards the control request to the determined control server to cause the determined control server to generate a control instruction and send the control instruction to a corresponding controller to control the corresponding smart device.

A control apparatus for a smart device according to an example embodiment of the present disclosure comprises:

a first receiving module configured to receive a control request sent by a user, wherein a room ID allocated to the user, a device ID of a to-be-controlled smart device, and first device execution information are carried in the control request;

a first determining module configured to determine, according to the room ID and a user ID of the user, a control permission of the user to control a smart device in a room corresponding to the room ID;

a second determining module configured to determine, according to the device ID, a control server corresponding to the device ID from control servers establishing a cooperative relationship with the control apparatus when the determined control permission allows control over the to-be-controlled smart device; and

a forwarding module configured to forward the control request to the determined control server, so that the determined control server generates a control instruction according to the first device execution information and sends the control instruction to a controller corresponding to the device ID to cause the controller to control the smart device.

A control apparatus for a smart device according to an example embodiment of the present disclosure comprises:

a receiving module configured to receive check-in confirmation information sent by a hotel management system, wherein the check-in confirmation information is generated by the hotel management system after a user checks in, and includes a room ID allocated by the hotel management system to the user;

an acquiring module configured to acquire, according to the check-in confirmation information, a control page for the user to control a smart device in a room corresponding to the room ID; and

a sending module configured to send, based on the control page, a control request to a network platform, wherein the room ID allocated to the user, a device ID of a to-be-controlled smart device, and first device execution information are carried in the control request, so that the network platform controls the to-be-controlled smart device according to the control request.

A control apparatus for a smart device according to an example embodiment of the present disclosure comprises:

a first receiving module configured to receive a control request sent by a hotel management system, wherein a device ID of a to-be-controlled smart device and first device execution information are carried in the control request;

a determining module configured to determine, according to the device ID, a control server corresponding to the device ID from control servers establishing a cooperative relationship with the gateway platform; and

a forwarding module configured to forward the control request to the determined control server, so that the determined control server generates a control instruction according to the first device execution information and sends the control instruction to a controller corresponding to the device ID to cause the controller to control the smart device.

As shown from the technical solutions according to the example embodiments of the present disclosure, in the example embodiments of the present disclosure, control servers of various IoT service providers are registered with a gateway platform, so that the gateway platform may be adapted to the control servers of the various IoT service providers, thus indirectly controlling respective controllers via the registered control servers. Moreover, a client terminal corresponding to the gateway platform may be provided to each hotel, so that the hotels may control smart devices by using controllers of the various IoT service providers via the gateway platform, without installing client terminals provided by the various IoT service providers. As such, if a hotel replaces a damaged controller with a controller of another IoT service provider or uses controllers of more than two IoT service providers at the same time, the hotel does not need to change a new client terminal or use more than two client terminals at the same time, thus improving the convenience for the user to use the IoT to control smart devices.

### BRIEF DESCRIPTION OF THE DRAWINGS

In order to describe the technical solutions in the example embodiments of the present disclosure or in the conventional techniques more clearly, the accompanying drawings to be used in the descriptions of the example embodiments or the conventional techniques will be briefly introduced as follow. It is apparent that the accompanying drawings in the following descriptions are merely an example embodiment described in the present disclosure. Those of ordinary skill in the art may further obtain other accompanying drawings according to these accompanying drawings without making creative efforts.

FIG. 1 is a schematic diagram of an existing control method for a smart device;

FIG. 2a is a schematic diagram of a control method for a smart device according to some example embodiments of the present disclosure;

FIG. 2b is a schematic diagram of a control method for a smart device in a hotel according to an example embodiment of the present disclosure;

FIG. 3 is a flowchart of a control method for a smart device according to an example embodiment of the present disclosure;

FIG. 4 is a flowchart of a control method for a smart device according to an example embodiment of the present disclosure;

FIG. 5 is a flowchart of a control method for a smart device in a hotel scenario according to an example embodiment of the present disclosure;

FIG. 6 is a schematic diagram of a control apparatus for a smart device according to an example embodiment of the present disclosure;

FIG. 7 is a schematic diagram of a control apparatus for a smart device according to an example embodiment of the present disclosure;

FIG. 8 is a schematic diagram of a control apparatus for a smart device according to an example embodiment of the present disclosure;

FIG. 9 is a schematic diagram of a control apparatus for a smart device according to an example embodiment of the present disclosure; and

FIG. 10 is a schematic diagram of a control apparatus for a smart device according to an example embodiment of the present disclosure.

### DETAILED DESCRIPTION

Control methods and apparatuses for a smart device are provided by an example embodiment of the present disclosure.

The method may be performed by a gateway platform, a smart cloud gateway, or a client terminal. The smart cloud gateway or the gateway platform herein is a platform-level device with a routing function, configured to send a control request to a control server corresponding to the control request. The client terminal is a client terminal installed on a terminal device of a user and interacting with the gateway platform or a client terminal installed on a hotel management system and interacting with the gateway platform.

To enable those skilled in the art to better understand the technical solutions in the present disclosure, the technical solutions in the example embodiments of the present disclosure will be clearly and completely described below with reference to the accompanying drawings in the example embodiments of the present disclosure. It is apparent that the example embodiments described are only some of not all the example embodiments of the present disclosure. All other example embodiments obtained by those of ordinary skill in the art based on the example embodiments in the present disclosure without making creative efforts should fall within the protection scope of the present disclosure.

As described above, in the technical field of the IoT, there are many IoT service providers providing users with smart device control services within the IoT, and each IoT service provider has developed its own controller and client terminal. If a user installs a controller of a certain IoT service provider, he/she has to use the client terminal provided by the IoT service provider. As such, if the user needs to use or add a controller of another IoT service provider in his/her own IoT, he/she also has to correspondingly change or add a client terminal of the IoT service provider. This reduces the convenience for the user to use the IoT to control a smart device.

The example embodiments of the present disclosure may be applied in a scenario where residents of a house are users and household devices in the house are smart devices, or where the manager and guests of a hotel are users and door locks, air conditioners, TVs and other devices in rooms of the hotel are smart devices. For ease of description, only the application scenario of a hotel is illustrated below as an example.

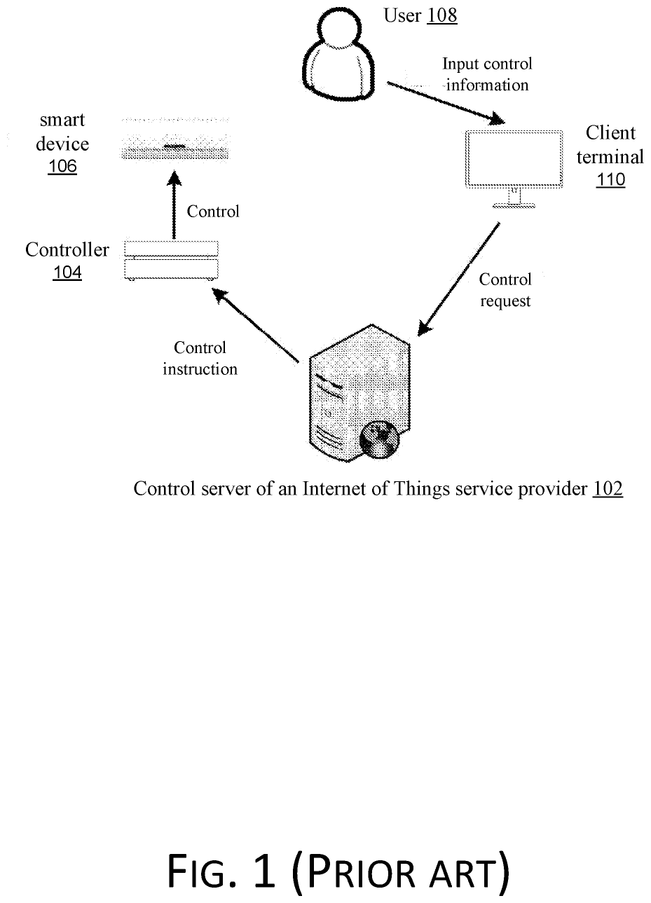

As shown in FIG. 1, according to an existing control method for a smart device, a control request sent by a user through a client terminal has to be processed by a control server of an IoT service provider, and the user may achieve the control over a smart device to be controller by the user only after the control server sends a control instruction to a controller corresponding to the smart device to be controlled by the user. In other words, it is the control server of the IoT service provider that directly controls the smart device, and the user only may indirectly control the smart device by sending the control request to the control server.

The controller herein may receive the control instruction by its own wireless signal interface or by a wired network to which the controller is connected. A network environment where the controller is located is a local area network in a hotel, the control server sends a control instruction to the controller in the local area network in the hotel via the Internet outside the hotel, and a gateway is needed to realize the connection between the Internet and the local area network. Thus, a gateway may be pre-installed in the hotel. For ease of description, the gateway is not mentioned in the following. The fact the control server sends a control instruction to the controller and the control instruction is received by the controller indicates that the connection between the Internet and the local area network has been realized via the gateway.

A device ID of a to-be-controlled smart device and first device execution information may be carried in the control request sent by the client terminal. The first device execution information may be, for example, contents such as turn on, turn off, 25° C., an intermediate level, and Channel 45 that the user wants to control the smart device to perform. Moreover, the device ID and the first device execution information may be control information input by the user at the client terminal, and the client terminal generates the control request according to the control information input by the user.

The user may select, in a user interface of the client terminal, a device ID of a smart device that the user wants to control and contents that the user wants the smart device to perform. For example, the user may select a device ID of “Oriental Hotel-407-Corridor Lamp” and device execution information of “turn on,” the client terminal generates, according to the user's selection, a control request carrying the foregoing information and sends the control request to the control server, and the control server generates a control instruction according to the control request to control a controller corresponding to the corridor lamp in Room 407 of the Oriental Hotel to be turned on.

In addition, in the hotel scenario, the existing control method for a smart device not only reduces the management convenience of the hotel but also makes it less convenient for guests checking in the hotel.

In the hotel application scenario, if a guest checking in a hotel room wants to control a smart device, the guest has three options. Option 1, the guest manually controls the smart device; Option 2, the guest installs a client terminal (service software) of an IoT service provider of the hotel that he/she checks in, and then inputs control information; and Option 3, the guest needs to make a request to the hotel, and then the hotel inputs into the client terminal control information requested by the guest. The above three options are not convenient enough for the guest.

It may be concluded from the foregoing introduction to the existing control method for a smart device that on one hand, the existing IoT service mode shown in FIG. 1 is advantageous in minimizing the control cost of the user. The IoT service provider is responsible for the maintenance of the client terminal, the controller, and the control server, and the user only needs to use the client terminal to send the control request.

On the other hand, just because of this, the control server, the controller, and the client terminal of each IoT service provider are highly coupled. In addition to the problem of inconvenience for the user to use the IoT, the following deficiencies are also caused. Due to the high degree of coupling among the control server, the controller, and the client terminal of each IoT service provider, various IoT service providers only may provide respective smart device control services separately, and there is no information sharing among them. Each IoT service provider only may provide a relatively simple smart device control service according to the device execution information carried in the control request sent by the user, but cannot further provide the user with a personalized service, that is, a service that further enhances the convenience of using the IoT to control a smart device by each user, based on user characteristics of the user.

For example, in a summer evening, a guest arrives at a hotel to check in at the reception. The hotel wants to provide a better service for the guest, and after determining a room number that the guest checked in is 206, the hotel sends a control request of “Turn on the air conditioner in Room 206 and sets the temperature to 20° C.” to a control server through a client terminal. According to the control request, the control server controls the air conditioner in the room to be turned on and set the temperature to 20° C. Unfortunately, the guest is so afraid of the cold that he/she catches a cold after entering the room.

For another example, a guest wants to watch TV programs after he/she wakes up in a hotel room, and he/she actually likes watching youth idol dramas. The guest operates a client terminal (a mobile phone), and selects a device ID of “Oriental Hotel-206-TV” and device execution information of “turn on and switch to Channel 25”. As the IoT service provider does not know the preference of the guest, it only supports the guest to select a certain channel on the TV set, and the guest then further needs to manually search dozens of TV channels for youth idol dramas.

It may be seen that the existing control method for a smart device in the IoT is disadvantageous in providing personalized service for users of the IoT.

For this reason, one of the example embodiments of the present disclosure may also solve the problem of insufficient personalized services provided for users, that is, by setting up a “gateway platform-client terminal” smart device control system. The smart control system is set up between a user and a control server of an IoT service provider, and supports the user to register a user ID with the gateway platform through the client terminal, thus presetting historical user behavior data corresponding to the user ID. In an actual application, the user ID of the user is further carried in a control request sent by the user to the gateway platform through the client terminal. The gateway platform analyzes the preference of the user according to the historical user behavior data corresponding to the user ID, so that the control instruction sent by the control server becomes more in line with the preference of the user, thus realizing a personalized control service of the smart device.

For example, in the foregoing example, the guest registered a user ID with the gateway platform, and the guest reserves a room at a hotel through the gateway platform. When the guest arrives at the hotel to check in at the reception, the hotel sends a control request with the following contents “user 221—turn on the air conditioner in Room 206 and set the temperature to 20° C.” to the gateway platform after determining a room number that the guest wants to check in. The gateway platform knows that the guest is very afraid of cold by analyzing according to the historical user behavior data corresponding to the user ID “user 221” of the user. Therefore, in addition to forwarding the control request to the control server, the gateway platform may also send second device execution information “set the temperature of the air conditioner in Room 206 to 28° C.” to the control server intelligently, and the control server uses the second device execution information preferentially and controls the temperature of the air conditioner to be set to 28° C., so that the guest will not feel cold after entering the room.

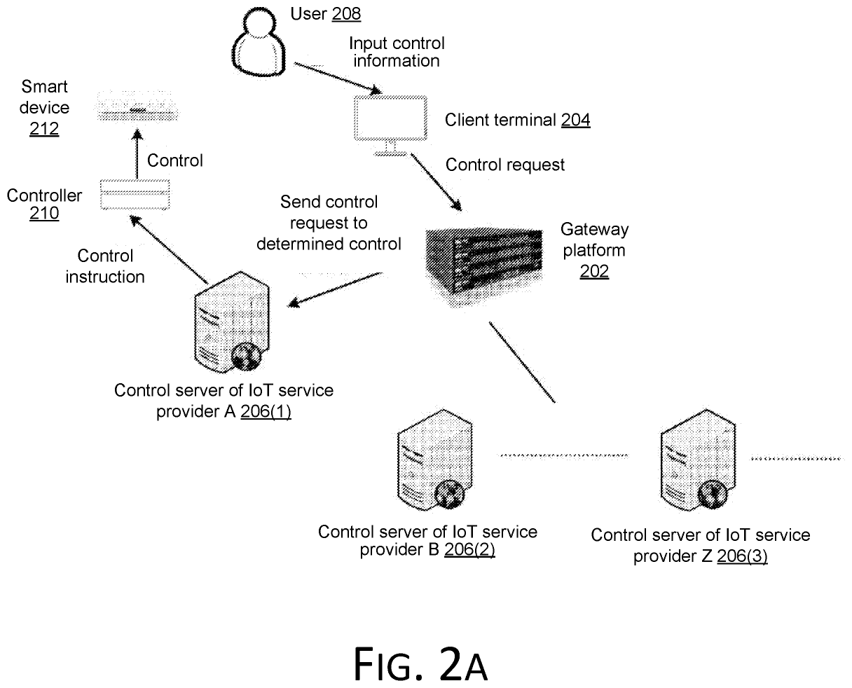

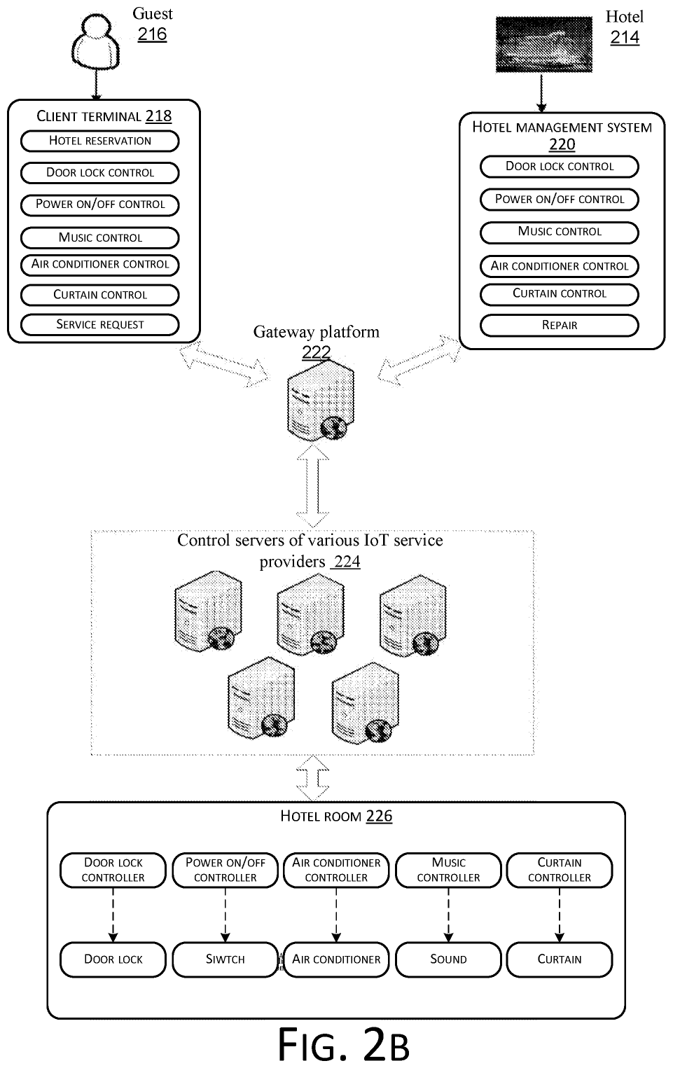

FIG. 2a is a schematic diagram of a control method for a smart device according to an example embodiment of the present disclosure. As shown in FIG. 2a, compared with the existing control method shown in FIG. 1, the architecture of a gateway device or gateway platform 202 is added, and the client terminal 204 is a universal terminal (adapted to different types of users and compatible with services of various IoT service providers) corresponding to the gateway platform.

Control servers of various IoT service providers such as IoT service provider A 206(1), IoT service provider B 206(2), IoT service provider Z 206(3) are pre-registered with a gateway platform, so that the client terminal 204 is decoupled from the control servers of the IoT (Internet of Things) service providers and the client terminal 204 becomes a universal terminal corresponding to the gateway platform 202. The control servers of the IoT service providers, such as IoT service provider A 206(1) and the controller installed by the IoT service providers, such as the controller 210, no longer uniquely correspond to the client terminal 204. A user 208 may send a control request to control servers of different IoT service providers via the client terminal 204 and the gateway platform 202. Thus, if the user 208 replaces a damaged controller with a controller of another IoT service provider or uses controllers of more than two IoT service providers at the same time, the user 208 does not need to change a new client terminal or use more than two client terminals at the same time, thus improving the convenience for the user to use the IoT to control a smart device 212.

FIG. 2b is a schematic diagram of a control method for a smart device in a hotel 214 according to an example embodiment of the present disclosure. As shown in FIG. 2b, a guest 216 (user) selects a service instruction via a client terminal 218. For example, the service instruction includes instruction such as hotel reservation, door lock control, power on/off control, music control, air conditioner control, curtain control, service request, etc. When the guest 216 selects a service instruction, the gateway platform 222 may forward the service request to a hotel management system 220.

After obtaining the service instruction, the hotel 214 may return a reply to the service instruction such as “please wait for a moment” to the gateway platform 222 through a hotel management system 220. The hotel management system 220 provides services corresponding to the service instructions sent by the client terminal 218, such as door lock control, power on/off control, music control, air conditioner control, curtain control, repair, etc.

The gateway platform 222 may forward the reply to the client terminal 218 of the guest 216. For another example, when the hotel 214 chooses to repair a controller, the gateway platform 222 may send a repair request to a control server from control servers of various IoT service providers 224, which corresponds to the controller that the hotel 214 chooses to repair. After receiving the repair request, the control server may return information such as time of on-site repair to the gateway platform 222, and the information is then forwarded by the gateway platform 222 to the hotel management system 220. The hotel management system 220 may be a system provided by the gateway platform 222 to the hotel 214 for use, or a system designated by the hotel 214 itself. When the hotel management system 220 is a system designated by the hotel itself, the gateway platform 222 may provide the hotel 214 with a hotel version client terminal installed on the hotel management system 220 to realize the connection between the gateway platform and the hotel management system.

Thus, the hotel management system 220 via the gateway platform 222 achieves management of different controllers from different IoT service provides at a hotel room 226 of the guest 216. For example, the door lock controller controls the door lock, the power on/off controller controls the switch, the air conditioner controller controls the air conditioner, the music controller controls the sound, and the curtain controller controls the curtain. These controllers may be from different IoT service providers.

In short, in the system architecture of “gateway platform-client terminal (universal)” provided by the present disclosure, the IoT function has strong expandability, and technical features readily conceived of by those skilled in the art may be added for various application scenarios in the system architecture based on the technical solutions of the example embodiments of the present disclosure, which will not be limited in the present disclosure.

The technical solutions provided by various example embodiments of the present disclosure are described below in detail with reference to the accompanying drawings.

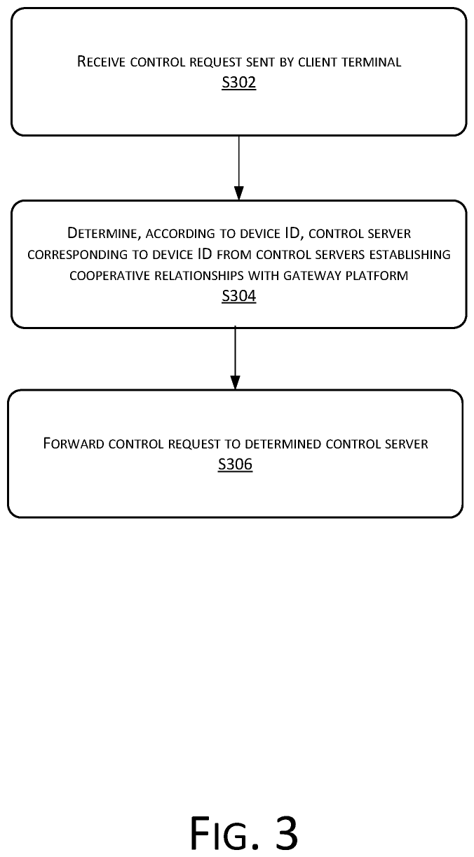

FIG. 3 is a flowchart of a control method for a smart device according to an example embodiment of the present disclosure, including the following steps.

S302, a control request sent by a client terminal is received.

The method may be performed by a gateway platform. The gateway platform may be a server or a cloud server that has data storage and data processing functions, and provides a gateway control protocol to the outside, for sending a control request to a control server corresponding to the control request. Each IoT service provider only needs to follow the gateway control protocol to connect the control server with the gateway platform.

In the example embodiments of the present disclosure, the first device execution information may be contents that the user wants a smart device corresponding to the device ID to perform, such as “turn on,” “turn off,” “Channel 25,” and “Level 2.” The second device execution information may be an operation performed by the smart device to meet personalization of the user, for example, setting the temperature of the air conditioner to 26° C. that is preferred by the user.

In the example embodiments of the present disclosure, the client terminal is a universal terminal corresponding to the gateway platform. That is, on one hand, both the hotel and the guest may use the client terminal (a hotel version client terminal and a guest version client terminal). On the other hand, the client terminal may also be compatible with services of various IoT service providers. When the client terminal is service software provided by the gateway platform, the hotel may install the service software on a terminal for hotel management, and the guest may install the service software on his/her terminal. In the example embodiments of the present disclosure, for ease of description, the client terminal refers to a client terminal used by the user (guest), and the hotel management system may refer to the hotel version client terminal.

As such, for the hotel, the client terminal is a universal terminal corresponding to the gateway platform, rather than a highly coupled dedicated terminal provided by an IoT service provider, and thus the hotel does not need to make any adjustment to the client terminal after using or adding a controller of another IoT service provider.

It should be noted that the IoT service provider selectable for the hotel should be an IoT service provider registered with the gateway platform. The client terminal may have different versions (hotel version and guest version). A user interface of the hotel version client terminal may provide a list of selectable IoT service providers for the hotel. After selecting an IoT service provider, the hotel sends a signing request to the gateway platform to sign with the IoT service provider. The guest version client terminal may support the guest to reserve the hotel on the client terminal, and may further provide other personalized services such as room advance payment, ticket reservation, and route planning.

For the guest, as there are a large number of hotels connected to the gateway platform, the guest may install the client terminal on a terminal, so that no matter which hotel the guest checks in, he/she may use the same client terminal to control a smart device in a hotel room.

The user may register with the gateway platform through the client terminal to obtain a user ID. At the same time, the gateway platform may record and collect historical user behavior data corresponding to user IDs to establish a user behavior database. For different user IDs, device execution data and/or user service data sent through the user IDs are/is collected, the collected device execution data and/or user service data are/is taken as historical user behavior data, and the user IDs and the historical user behavior data are stored in the user behavior database.

For example, for each user ID, first device execution information sent through the user ID historically may be recorded in advance as historical user behavior data corresponding to the user ID. For example, if device execution information “TV channel 25” has been historically sent through the user ID, the device execution information is determined as the historical user behavior data. Further, the historical user behavior data corresponding to the user ID may be ranked by reference value according to the frequency of occurrence of different first device execution information sent through the same user ID.

In the example embodiments of the present disclosure, the gateway platform may also receive and store data sent by various client terminals and generated on the client terminals through various user IDs as historical user behavior data. For example, when the client terminal further provides services such as ticket reservation, taxi calling, and a map, data such as a destination to which the user calls a taxi at the client terminal through the user ID is recorded by the client terminal and sent to the gateway platform as the historical user behavior data of the user ID.

When the gateway platform is associated with a user ID (such as an IP address, a mac address, or an account of common software or a general website) registered by the user on the Internet, big data generated on the Internet through the user ID may also be collected as historical user behavior data corresponding to the user ID. For example, the gateway platform may be associated with a user ID of the user registered with an e-commerce platform, and the user may also log on to the client terminal with the user ID registered with the e-commerce platform. As such, the gateway platform may cooperate with the e-commerce platform to acquire big data (such as shopping records and a delivery address) generated by the user on the e-commerce platform as historical user behavior data.

In the example embodiments of the present disclosure, a device ID and first device execution information selected by the user are carried in the control request, and the user may select a device ID and device execution information from device IDs and first device execution information listed in a user interface of the client terminal, or input a keyword in the user interface and select a device ID and device execution information in an interface of returned results.

For example, the device ID may not include a controller ID of the controller and a server ID of the control server; for example, “Oriental Hotel-205-air conditioner” only indicates the air conditioner in Room 205 of the Oriental Hotel. The device ID may include a controller ID of the controller and a server ID of the control server; for example, “Oriental Hotel-205-air conditioner-controller 110-server 8” also indicates that the controller ID of the controller that controls the air conditioner is 110 and the server ID of the control server that sends an instruction to the controller is 8.

S304, a control server corresponding to the device ID is determined from control servers establishing a cooperative relationship with the gateway platform, according to the device ID.

In the example embodiments of the present disclosure, in order to decouple control servers from the client terminal, control servers of various IoT service providers are registered with the gateway platform. In other words, mapping relationships between device IDs of different smart devices and server IDs of control servers that control the smart devices are stored in the gateway platform.

For example, the mapping relationships between device IDs of different smart devices and server IDs of control servers that control the smart devices may be established by:

receiving and storing server IDs of control servers of various IoT service providers establishing a cooperative relationship with the gateway platform, controller IDs of controllers installed by the various IoT service providers, and device IDs of smart devices; for each device ID, determining a controller ID of a controller that controls a smart device corresponding to the device ID, and establishing a first correspondence between the device ID and the controller ID of the determined controller; and for each server ID, determining a controller ID of a controller installed by an IoT service provider corresponding to the server ID, and establishing a second correspondence between the server ID and the controller ID of the determined controller; and obtaining, according to the first correspondence and the second correspondence, mapping relationships among the device IDs of different smart devices, the controller IDs of controllers that control the smart devices, and the server IDs of control servers that control the controllers of the smart devices.

It is also possible to directly receive a mapping table between device IDs of different smart devices provided by various IoT service providers and server IDs of control servers that control the smart devices.

In the example embodiments of the present disclosure, the gateway platform may determine a server ID corresponding to the device ID in pre-registered server IDs of control servers according to the device ID carried in the control request; and determine a control server corresponding to the determined server ID as the control server corresponding to the device ID.

For example, a server ID corresponding to the device ID carried in the control request may be determined according to the mapping relationships among the device IDs of different smart devices, the controller IDs of controllers that control the smart devices, and the server IDs of control servers that control the controllers of the smart devices. A control server corresponding to the determined server ID may be determined as the control server corresponding to the device ID.

S306, the control request is forwarded to the determined control server.

In the example embodiments of the present disclosure, after determining the control server corresponding to the device ID, the gateway platform forwards the received control request to the control server. The control server generates a control instruction according to the control request and then sends the control instruction to a controller corresponding to the device ID. The controller controls a smart device corresponding to the device ID according to the control instruction.

For example, if the control instruction is “unlock the door after 5 minutes,” a timing unit in the controller starts after the control instruction is received, and triggers the controller to unlock the door after 5 minutes.

In the various example embodiments of the present disclosure, the device ID and the device execution information selected by the user are carried in the control information, the control request, and the control instruction.

In the example embodiments of the present disclosure, the control request may be encapsulated according to a set gateway control protocol, and the encapsulated control request is sent to the determined control server, so that the determined control server parses the encapsulated control request to obtain a to-be-controlled device ID and the first device execution information, generates a control instruction according to the first device execution information, and sends the control instruction to a controller corresponding to the device ID to cause the controller to control the smart device.

The gateway control protocol herein may be a rule by which the gateway platform or the smart cloud gateway interacts with various control servers. The reason why the interaction between the gateway platform and the various control servers should depend on the gateway control protocol is to ensure that the control servers may parse the control request accurately when the control request forwarded by the gateway platform is received, so as to acquire the device ID of the smart device to be controlled, the first device execution information, the second device execution information, and so on.

For example, the gateway platform or the smart cloud gateway may write the device ID of the smart device to be controlled and the device execution information into a designated field of the set gateway control protocol. As such, when a control request sent by the gateway platform or the smart cloud gateway according to the set gateway control protocol is received, the control server may obtain the device ID of the smart device to be controlled and the device execution information by parsing, thus achieving the control over the smart device.

In addition, in the example embodiments of the present disclosure, the second device execution information may also be generated according to the historical user behavior data of the user, so that the control server sends the control instruction to the controller more precisely according to the second device execution information, thus achieving personalized control over the smart device.

In the example embodiments of the present disclosure, when the user ID of the user is further carried in the control request, the gateway platform may perform the following steps after the control server corresponding to the device ID is determined in the control servers pre-registered: searching, according to the user ID, a user behavior database for historical user behavior data corresponding to the user ID, the user behavior database including mapping relationships between user IDs and historical user behavior data; generating second device execution information according to the device ID and the historical user behavior data; and sending the second device execution information to the determined control server, so that the control server sends the second device execution information to a controller corresponding to the device ID to cause the controller to control the smart device according to the control instruction and the second device execution information.

The foregoing steps may be performed at any time after the control server corresponding to the device ID is determined and before the controller controls the corresponding smart device. Preferably, the foregoing steps may be performed after the control server corresponding to the device ID is determined and before the control server generates the control instruction. As such, the control server corresponding to the device ID may add the received second device execution information to the control instruction and send them to the controller corresponding to the device ID together.

For example, a device type of the smart device corresponding to the device ID is determined according to the device ID; historical user behavior data related to the device type is determined according to the device type from the historical user behavior data corresponding to the user ID; user behavior characteristics of the user corresponding to the user ID who controls the smart device are determined according to the historical user behavior data; and the second device execution information is generated according to the user behavior characteristics.

The user behavior database may be determined by: for different user IDs, collecting device execution data and/or user service data sent through the user IDs, determining the collected device execution data and/or user service data as historical user behavior data, and storing the user IDs and the historical user behavior data into the user behavior database.

For example, big data generated by a user A over the Internet is stored on a gateway platform as historical user behavior data. One day, if the user A checks in a hotel and the hotel wants to turn on an air conditioner in advance, when the gateway platform receives a control request sent by the hotel through a client terminal, the gateway platform determines according to a device ID carried in the control request that the device type is an air conditioner, determines historical user behavior data corresponding to the user A according to a user ID A of the user A carried in the control request, then screens out historical user behavior data related to the air conditioner (e.g., the user A once bought a cotton-padded jacket online in summer) from the historical user behavior data corresponding to the user A, and determines according to the screened historical user behavior data that the user characteristic of the user A is “afraid of cold.” Therefore, a device parameter of the air conditioner is set to “28° C.” (or other warmer temperatures), and second device execution information “turn on the air conditioner and set the temperature to 28° C.” is generated finally.

In the example embodiments of the present disclosure, in a hotel scenario, a guest may complete reservation of a hotel room through a client terminal in advance, and the hotel may verify identity information of the guest through the client terminal when the guest arrives at the hotel to check in. For example, the hotel may ask the guest to show a verification code sent by the gateway platform. After verifying the identity of the guest, the hotel synchronizes check-in information of the guest (a user ID of the guest and a room number of the guest) to the gateway platform. The gateway platform intelligently generates second device execution information according to the received check-in information and sends the second device execution information to a corresponding control server, thus achieving personalized control over a smart device in the room that the guest checks in and creating a convenient check-in experience in advance for the guest, such as, turning on the air conditioner in advance and setting to an appropriate temperature, turning on the TV set in advance and setting to the user's favorite channel, playing the user's favorite music in advance, and so on. Certainly, the hotel and the guest may also send a control request to the gateway platform through the client terminal at any time to achieve the control over the smart device.

Finally, it should be emphasized that in an application scenario where a guest uses a guest version client terminal to control a smart device in a room, for the sake of security of the hotel manager and in order to prevent a guest not checking in the room from abusing a control permission, when a guest arrives at the hotel to check in at the reception, the hotel may send a permission granting request to the gateway platform to grant the guest a control permission for the smart device in the room that the guest checks in after the room that the guest checks in is determined. Alternatively, after the gateway platform receives guest check-in information synchronized by the hotel, the gateway platform may automatically grant the guest a permission to control the smart device in the corresponding room.

According to the method shown in FIG. 3, control servers of various IoT service providers are registered with a gateway platform, so that the gateway platform may be adapted to the control servers of the various IoT service providers, and then may indirectly control various controllers through the registered control servers. Moreover, a client terminal corresponding to the gateway platform may be provided to various hotels, so that the hotels may control smart devices by using the controllers of the various IoT service providers through the gateway platform without installing client terminals provided by the various IoT service providers. As such, if a hotel replaces a damaged controller with a controller of another IoT service provider or uses controllers of more than two IoT service providers at the same time, the hotel does not need to change a new client terminal or use more than two client terminals at the same time, thus improving the convenience for the user to use the IoT to control a smart device.

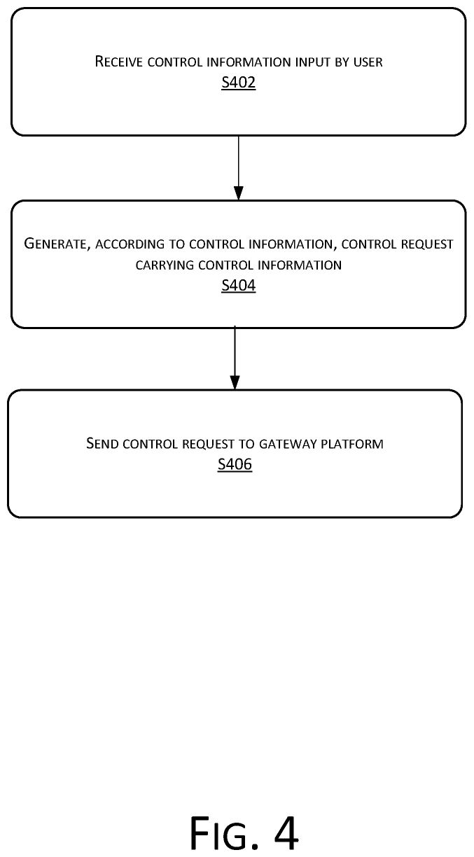

FIG. 4 is a flowchart of a control method for a smart device according to an example embodiment of the present disclosure, including the following steps.

S402, control information input by a user is received.

The method is performed by a client terminal used by the user.

S404, a control request carrying the control information is generated according to the control information.

In the example embodiments of the present disclosure, the control information includes a device ID and device execution information selected by the user.

In the example embodiments of the present disclosure, if the user registers with a gateway platform through the client terminal to obtain a user ID, or the gateway platform is associated with a user ID that has been registered with the Internet by the user, the user ID of the user may further be carried in the control request generated by the client terminal.

S406, the control request is sent to the gateway platform.

As the method shown in FIG. 4 and the method shown in FIG. 3 are technical solutions based on the same invention concept, the method shown in FIG. 4 has been described in detail in the present specification and will not be elaborated.

Based on the foregoing control method for a smart device, a control apparatus for a smart device is further provided in an example embodiment of the present disclosure correspondingly.

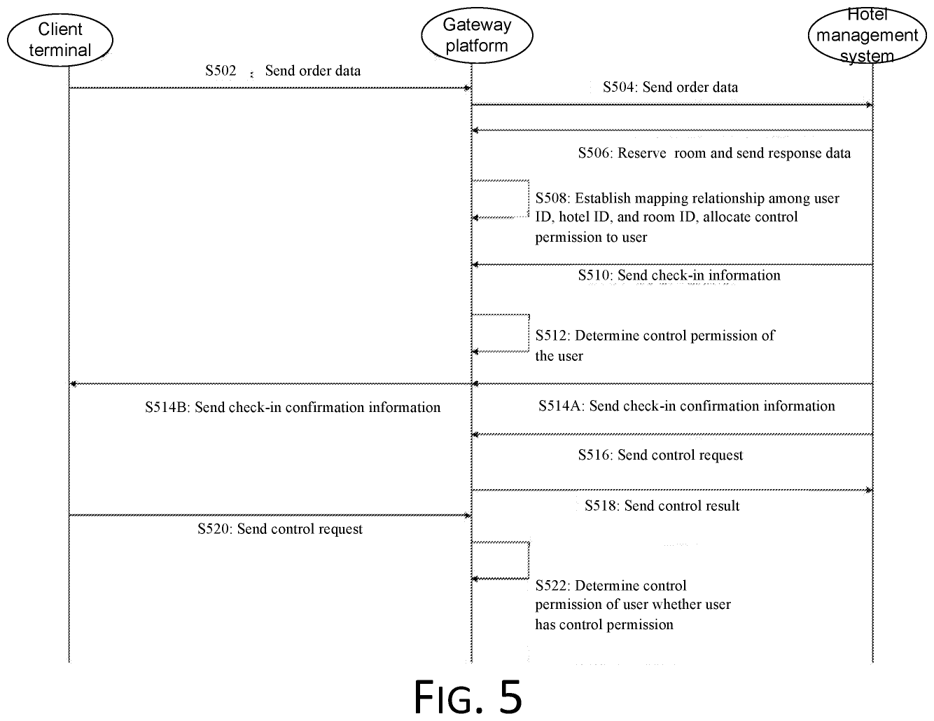

FIG. 5 is a flowchart of a control method for a smart device in a hotel scenario according to an example embodiment of the present disclosure, including the following steps.

S502, a gateway platform receives order data sent by a client terminal.

In the example embodiments of the present disclosure, the order data includes a hotel ID selected by the user. The user operates in an interface of the client terminal to select a hotel ID of a hotel that the user wants to check in, and the client terminal sends generated order data to the gateway platform. It should be noted that the order data may further include data such as the expected check-in time of the user and the type of a room selected by the user.

S504, the gateway platform sends the order data to a hotel management system.

In the example embodiments of the present disclosure, the gateway platform may send the order data to the hotel management system to inform the hotel management system that the user has reserved a room.

S506, the hotel management system reserves room and sends response data to the gateway platform. For example, the hotel management system allocates a check-in room to the user according to the order data, and sends response data to the gateway platform.

The hotel management system allocates the check-in room to the user according to data such as the check-in time of the user and the type of the room that the user wants to check in, and sends the response data to the gateway platform to inform the gateway platform that the order has been received and a room has been reserved for the user. The response data may include a room ID of the room allocated to the user and the hotel ID.

S508, the gateway platform establishes a mapping relationship among the user ID, the hotel ID, and the room ID according to the received response data, and allocates a control permission to the user.

After the response data is received, the gateway platform needs to allocate a control permission for a smart device to the user according to the expected check-in time of the user, the hotel ID of the hotel that the user is to check in, and the room ID of the room of the hotel that the user is to check in. In other words, according to room reservation fed back by the hotel management system, the gateway platform may grant the user a permission to control a smart device in the room during a specific time period in a specific room of a specific hotel.

So far, the user has successfully reserved the hotel room, and preparations before the user arrives at the hotel to check in on the check-in day have been completed.

S510, the hotel management system sends check-in information to the gateway platform.

This step is performed when the user arrives at the hotel to check in on the check-in day. The user may show the hotel a verification code, a QR code, or another electronic certificate shown on the client terminal, and after successful verification, the hotel management system permits the user to check in and sends check-in information to the gateway platform.

The check-in information includes a room ID allocated by the hotel management system to the user and check-in time.

S512, the gateway platform determines a control permission of the user to control a smart device in a room corresponding to the room ID.

In the example embodiments of the present disclosure, if the gateway platform has not received the response data sent by the hotel management system before, the gateway platform may not be able to allocate a control permission to the user. Then, in this case, when the user checks in, the gateway platform will also receive the check-in information sent by the hotel management system, and the gateway platform may also allocate a control permission to the user according to the check-in time and the room ID included in the check-in information, that is, establish a mapping relationship among the user ID, the room ID, and the control permission.

S514A, the hotel management system sends check-in confirmation information to the gateway platform so that the gateway platform grants the control permission of the user to control the smart device in the room corresponding to the room ID; and the client terminal acquires a control page after the check-in confirmation information is received.

In the example embodiments of the present disclosure, the check-in confirmation information is generated by the hotel management system after the user checks in.

In the step S514, the gateway platform has determined the control permission of the user, and when further receiving the check-in confirmation information sent by the hotel management system, the gateway platform may grant the user the control permission.

S514B: In this case, the client terminal used by the user will also receive the check-in confirmation information sent by the hotel management system, and will acquire a control page. The control page may be a control page of the client terminal used by the user as shown in FIG. 2b.

S516, the hotel management system sends a control request to the gateway platform.

When the control request sent by the hotel management system is received, the gateway platform forwards the control request to the determined control server to control the corresponding smart device.

In the example embodiments of the present disclosure, in order to better serve the user, the hotel may send a control request to the gateway platform after completing the check-in procedure for the user. A device ID of a to-be-controlled smart device and first device execution information are carried in the control request. That is, before the user enters the room, the hotel controls the smart device in the room in advance. The first device execution information may be setting an air conditioner to an appropriate temperature, automatically unlocking a door lock, closing the curtain, and so on.

Further, as illustrated previously in the description of the control method for a smart device shown in FIG. 3, the gateway platform may further search, according to the user ID, a user behavior database for historical user behavior data corresponding to the user ID, the user behavior database including mapping relationships between user IDs and historical user behavior data; and generate second device execution information according to the device ID and the historical user behavior data.

Then, the control request and the second device execution information are sent to the determined control server together, so that the control server generates the control instruction according to the second device execution information and the first device execution information in the control request and sends the control instruction to the controller corresponding to the device ID to cause the controller to control the smart device. As such, a personalized service may be provided to the user.

S518, the hotel management system receives a control result sent by the control server, and the control result is sent to the hotel management system.

After the gateway platform sends the control request to the corresponding control server and further controls the corresponding smart device, the control server will feed back a control result to the gateway platform. The control result is used for representing a result of controlling the smart device by the controller according to the control instruction. Then, the gateway platform may send the control result to the hotel management system to prompt the hotel management system the control result for the smart device.

So far, the hotel management system has completed the check-in procedure for the user, and appropriately controlled a smart device in a room that the user is to enter, thus providing a personalized service for the user. After that, the user enters the room, and may send a control request to the gateway platform through the client terminal installed in his/her terminal to control the smart device in the room that the user checks in.

In addition, even if no user needs to check in, the hotel management system may also send a control request to the gateway platform for the purpose of managing smart devices in rooms, thus achieving unified control over the smart devices in rooms.

S520, the gateway platform receives the control request sent by the client terminal.

As stated above, in step S516, the client terminal acquires the control page after a check-in confirmation request is received. In this step, the user may send the control request to a network platform by clicking an option in the control page, wherein the room ID allocated to the user, the device ID of a to-be-controlled smart device, and the first device execution information are carried in the control request, so that the network platform controls the to-be-controlled smart device according to the control request.

S522, the gateway platform determines, according to the room ID and the user ID of the user, a control permission of the user to control the smart device in the room corresponding to the room ID.

After the control request sent by the user is received, the network platform first needs to determine whether the user has a permission to control the smart device corresponding to the device ID.

If the user is determined to have control permission, the corresponding smart device is controlled; otherwise, the corresponding smart device is not controlled.

When the determined control permission allows control over the to-be-controlled smart device, a control server corresponding to the device ID is determined according to the device ID from control servers establishing a cooperative relationship with the gateway platform, and the control request is forwarded to the determined control server.

When the user is determined to have the permission to control the smart device corresponding to the device ID, the gateway platform may feed back a result to the client terminal, so that the control permission is displayed in the control page.

When the determined control permission refuses the control over the to-be-controlled smart device, the gateway platform sends a prompt message to the client terminal to remind the user of a control failure.

Similarly, the gateway platform may also control the corresponding smart device according to historical user behavior characteristics of the user, which will not be elaborated.

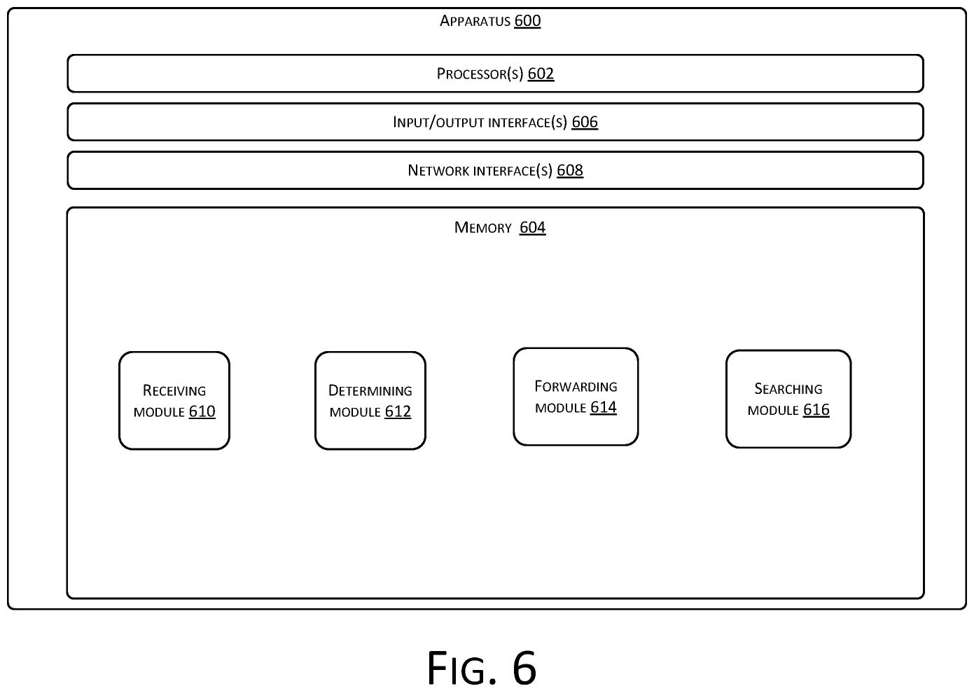

FIG. 6 is a schematic diagram of a control apparatus 600 for a smart device according to an example embodiment of the present disclosure.

As shown in FIG. 6, the apparatus 600 includes one or more processor(s) 602 or data processing unit(s) and memory 604. The apparatus 600 may further include one or more input/output interface(s) 606 and one or more network interface(s) 608. The memory 604 is an example of computer readable medium or media.

The memory 604 may store therein a plurality of modules or units including:

a receiving module 610 configured to receive a control request sent by a client terminal, wherein a device ID of a to-be-controlled smart device and first device execution information are carried in the control request;

a determining module 612 configured to determine, according to the device ID, a control server corresponding to the device ID from control servers establishing a cooperative relationship with the control apparatus, wherein mapping relationships between device IDs of different smart devices and server IDs of control servers that control the smart devices are stored in the control apparatus; and

a forwarding module 614 configured to forward the control request to the determined control server, so that the determined control server generates a control instruction according to the first device execution information and sends the control instruction to a controller corresponding to the device ID to cause the controller to control the smart device.

The mapping relationships between device IDs of different smart devices and server IDs of control servers that control the smart devices are established by: receiving and storing server IDs of control servers of IoT service providers establishing a cooperative relationship with the control apparatus, controller IDs of controllers installed by the IoT service providers, and device IDs of smart devices; for each device ID, determining a controller ID of a controller that controls a smart device corresponding to the device ID, and establishing a first correspondence between the device ID and the controller ID of the determined controller; and for each server ID, determining a controller ID of a controller installed by an IoT service provider corresponding to the server ID, and establishing a second correspondence between the server ID and the controller ID of the determined controller; and obtaining, according to the first correspondence and the second correspondence, mapping relationships among the device IDs of different smart devices, the controller IDs of controllers that control the smart devices, and the server IDs of control servers that control the controllers of the smart devices.

The determining module 612 is configured to determine, according to the mapping relationships among the device IDs of different smart devices, the controller IDs of controllers that control the smart devices, and the server IDs of control servers that control the controllers of the smart devices, a server ID corresponding to the device ID carried in the control request; and determine a control server corresponding to the determined server ID as the control server corresponding to the device ID.

The forwarding module 614 is configured to encapsulate the control request according to a set gateway control protocol, and send the encapsulated control request to the determined control server, so that the determined control server parses the encapsulated control request to obtain a to-be-controlled device ID and the first device execution information, generates the control instruction according to the first device execution information, and sends the control instruction to the controller corresponding to the device ID to cause the controller to control the smart device.

A user ID of a user is further carried in the control request.

The apparatus 600 may further include a searching module 616 stored in the memory 604. The searching module 616 is configured to search, according to the user ID after the control server corresponding to the device ID is determined, a user behavior database for historical user behavior data corresponding to the user ID, the user behavior database including mapping relationships between user IDs and historical user behavior data; generate second device execution information according to the device ID and the historical user behavior data; and send the second device execution information to the determined control server, so that the control server sends the second device execution information to the controller corresponding to the device ID to cause the controller to control the smart device according to the control instruction and the second device execution information.

The searching module 616 is also configured to determine, according to the device ID, a device type of the smart device corresponding to the device ID; determine, according to the device type, historical user behavior data related to the device type from the historical user behavior data corresponding to the user ID; determine, according to the historical user behavior data, user behavior characteristics of the user corresponding to the user ID who controls the smart device; and generate the second device execution information according to the user behavior characteristics.

The user behavior database is obtained, for example, by: for different user IDs, collecting device execution data and/or user service data sent through the user IDs, determining the collected device execution data and/or user service data as historical user behavior data, and storing the user IDs and the historical user behavior data into the user behavior database.

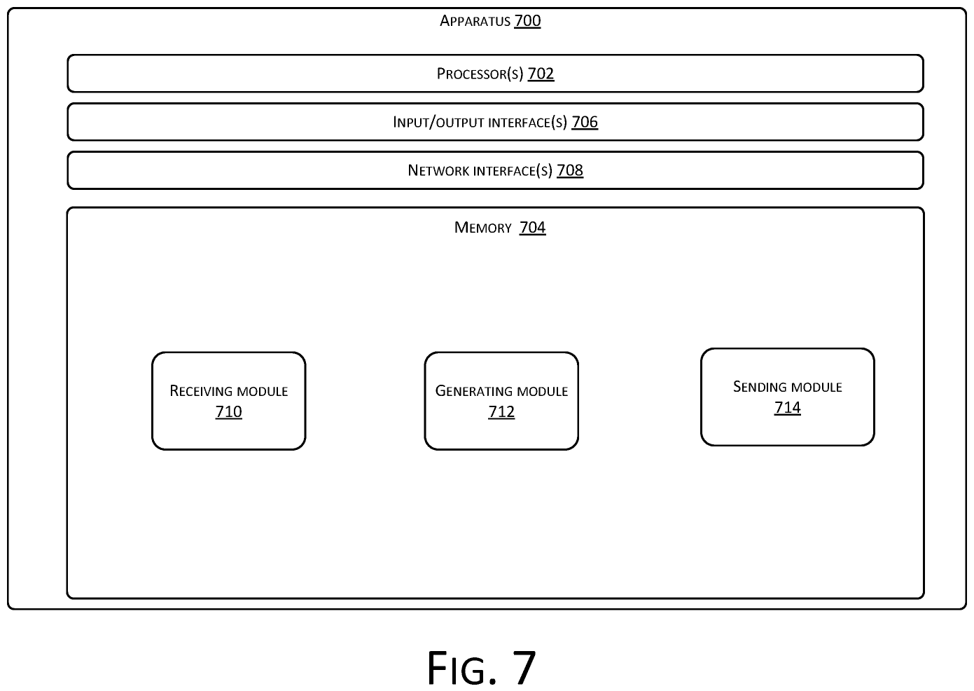

FIG. 7 is a schematic diagram of a control apparatus 700 for a smart device according to an example embodiment of the present disclosure, applied to a gateway platform.

As shown in FIG. 7, the apparatus 700 includes one or more processor(s) 702 or data processing unit(s) and memory 704. The apparatus 700 may further include one or more input/output interface(s) 706 and one or more network interface(s) 708. The memory 704 is an example of computer readable medium or media.

The memory 704 may store therein a plurality of modules or units including:

a receiving module 710 configured to receive control information input by a user, the control information including a device ID of a to-be-controlled smart device and first device execution information;

a generating module 712 configured to generate, according to the control information, a control request carrying the control information; and

a sending module 714 configured to send a control request to the gateway platform, so that the gateway platform determines a control server corresponding to the device ID according to the device ID from control servers establishing a cooperative relationship with the gateway platform, and forwards the control request to the determined control server to cause the determined control server to generate a control instruction and send the control instruction to a corresponding controller to control the corresponding smart device.

The generating module 712 is configured to generate, according to the control information, the control request carrying the control information and a user ID of the user, so that the gateway platform receiving the control request searches, according to the user ID, the user behavior database for historical user behavior data corresponding to the user ID and then controls the corresponding smart device according to the historical user behavior data.

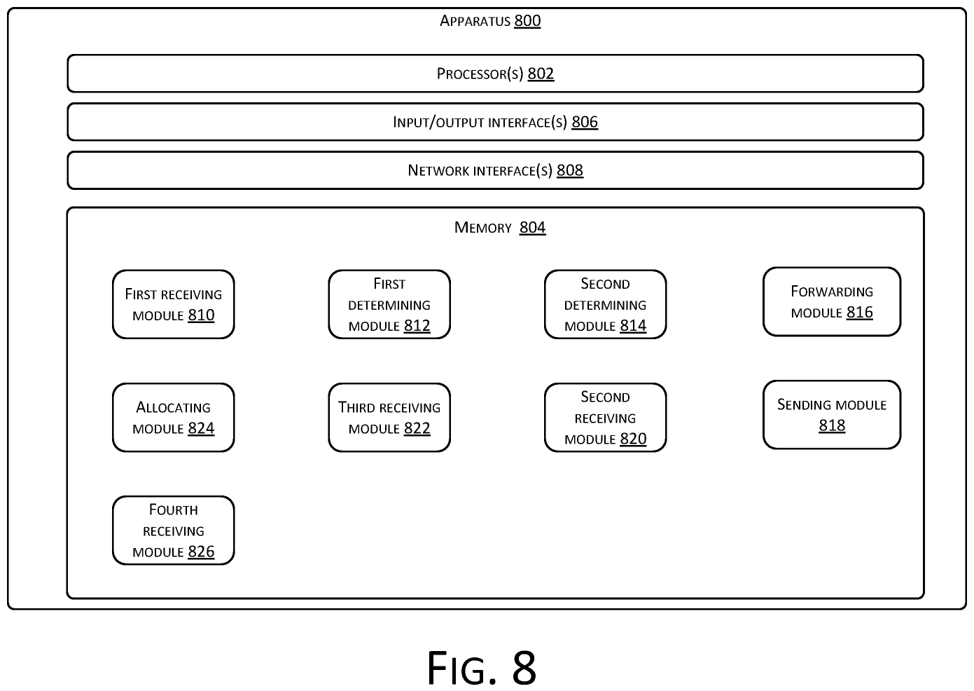

FIG. 8 is a schematic diagram of a control apparatus 800 for a smart device according to an example embodiment of the present disclosure.

As shown in FIG. 8, the apparatus 800 includes one or more processor(s) 802 or data processing unit(s) and memory 804. The apparatus 800 may further include one or more input/output interface(s) 806 and one or more network interface(s) 808. The memory 804 is an example of computer readable medium or media.

The memory 804 may store therein a plurality of modules or units including:

a first receiving module 810 configured to receive a control request sent by a user, wherein a room ID allocated to the user, a device ID of a to-be-controlled smart device, and first device execution information are carried in the control request;

a first determining module 812 configured to determine, according to the room ID and a user ID of the user, a control permission of the user to control a smart device in a room corresponding to the room ID;

a second determining module 814 configured to determine, according to the device ID, a control server corresponding to the device ID from control servers establishing a cooperative relationship with the control apparatus when the determined control permission allows control over the to-be-controlled smart device; and

a forwarding module 816 configured to forward the control request to the determined control server, so that the determined control server generates a control instruction according to the first device execution information and sends the control instruction to a controller corresponding to the device ID to cause the controller to control the smart device.

The apparatus 800 may further include a sending module 818 stored in the memory 804 and configured to send a prompt message to remind the user of a control failure when the determined control permission refuses the control over the to-be-controlled smart device.

The apparatus 800 may further include a second receiving module 820 stored in the memory 804 and configured to receive check-in information sent by a hotel management system before the control request sent by the user is received, wherein the check-in information is generated by the hotel management system after confirmation information about user's check-in is received, and includes a room ID allocated by the hotel management system to the user and check-in time; and determine, according to the check-in time, a control permission of the user to control a smart device in a room corresponding to the room ID, and establish a mapping relationship among the user ID, the room ID, and the control permission.

The apparatus 800 may further include a third receiving module 822 stored in the memory 804 and configured to receive order data sent by the user, the order data including a hotel ID selected by the user; send the order data to a hotel management system corresponding to the hotel ID, so that the hotel management system allocates a check-in room to the user according to the order data; receive response data sent by the hotel management system, the response data including the room ID of the room allocated to the user and the hotel ID; and establish a mapping relationship among the user ID, the hotel ID, and the room ID.

The apparatus 800 may further include an allocating module 824 stored in the memory 804 and configured to, when the response data sent by the hotel management system is received, allocate, according to check-in time included in the order data and indicating when the user checks in a hotel corresponding to the hotel ID, to the user a control permission of the user to control a smart device in the room corresponding to the room ID.

The apparatus 800 may further include a fourth receiving module 826 stored in the memory 804 and configured to receive check-in confirmation information sent by the hotel system, the check-in confirmation information being generated by the hotel management system after the user checks in; and when the check-in confirmation information is received, grant the control permission of the user to control the smart device in the room corresponding to the room ID.

The apparatus 800 may further includes a searching module 828 stored in the memory 804 and configured to search, according to the user ID after the control server corresponding to the device ID is determined, a user behavior database for historical user behavior data corresponding to the user ID, the user behavior database including a mapping relationship between user IDs and historical user behavior data; and generate second device execution information according to the device ID and the historical user behavior data; and

the forwarding module 804 is configured to send the control request and the second device execution information together to the determined control server, so that the control server generates a control instruction according to the second device execution information and the first device execution information in the control request and sends the control instruction to the controller corresponding to the device ID to cause the controller to control the smart device.

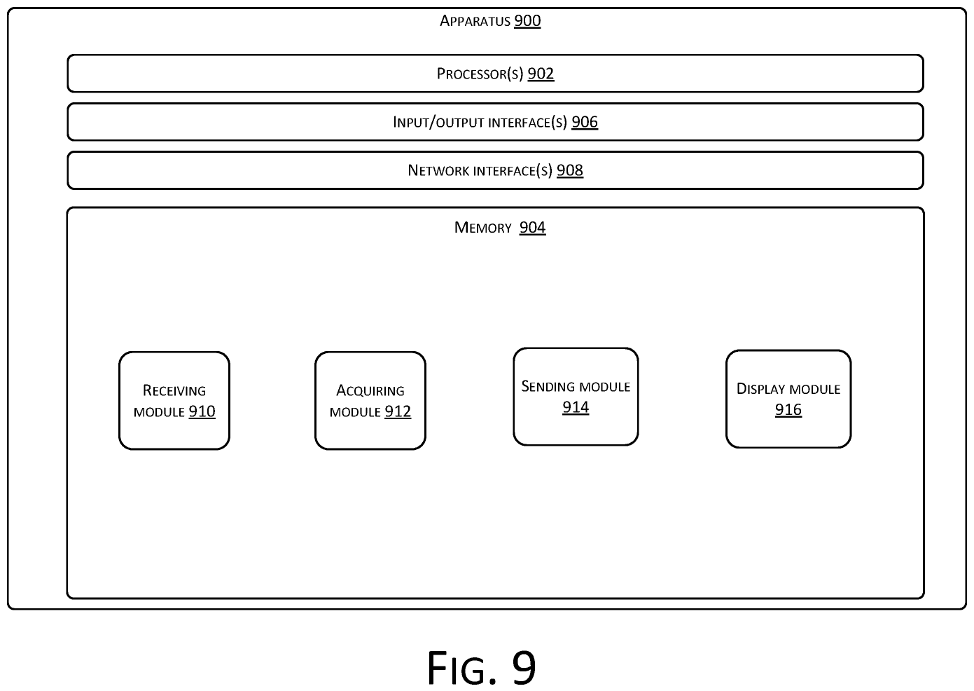

FIG. 9 is a schematic diagram of a control apparatus 900 for a smart device according to an example embodiment of the present disclosure.

As shown in FIG. 9, the apparatus 900 includes one or more processor(s) 902 or data processing unit(s) and memory 904. The apparatus 900 may further include one or more input/output interface(s) 906 and one or more network interface(s) 908. The memory 904 is an example of computer readable medium or media.

The memory 904 may store therein a plurality of modules or units including:

a receiving module 910 configured to receive check-in confirmation information sent by a hotel management system, wherein the check-in confirmation information is generated by the hotel management system after a user checks in, and includes a room ID allocated by the hotel management system to the user;

an acquiring module 912 configured to acquire, according to the check-in confirmation information, a control page for the user to control a smart device in a room corresponding to the room ID; and

a sending module 914 configured to send, based on the control page, a control request to a network platform, wherein the room ID allocated to the user, a device ID of the to-be-controlled smart device, and first device execution information are carried in the control request, so that the network platform controls a to-be-controlled smart device according to the control request.

The apparatus 900 may further include a display module 916 stored in the memory 904 and configured to determine, according to the check-in confirmation information, a control permission of the user to control the smart device in the room corresponding to the room ID; and display the control permission in the control page.

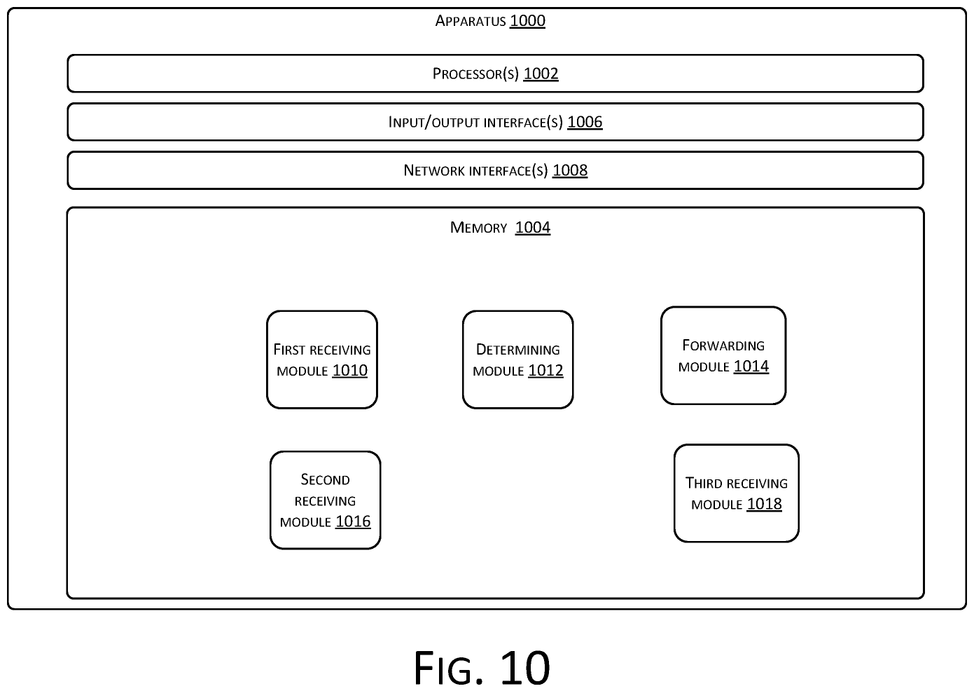

FIG. 10 is a schematic diagram of a control apparatus 1000 for a smart device according to an example embodiment of the present disclosure.

As shown in FIG. 10, the apparatus 1000 includes one or more processor(s) 1002 or data processing unit(s) and memory 1004. The apparatus 1000 may further include one or more input/output interface(s) 1006 and one or more network interface(s) 1008. The memory 1004 is an example of computer readable medium or media.

The memory 1004 may store therein a plurality of modules or units including:

a first receiving module 1010 configured to receive a control request sent by a hotel management system, wherein a device ID of a to-be-controlled smart device and first device execution information are carried in the control request;

a determining module 1012 configured to determine, according to the device ID, a control server corresponding to the device ID from control servers establishing a cooperative relationship with the gateway platform; and

a forwarding module 1014 configured to forward the control request to the determined control server, so that the determined control server generates a control instruction according to the first device execution information and sends the control instruction to a controller corresponding to the device ID to cause the controller to control the smart device.

Sending time of the control instruction is further carried in the control request; and

the forwarding module 1014 is configured to forward the control request to the determined control server according to the sending time.

The apparatus 1000 may further include a second receiving module 1016 stored in the memory 1004 and configured to, before the control request sent by the hotel management system is received, receive check-in confirmation information sent by the hotel management system, wherein the check-in confirmation information is generated by the hotel management system after a user checks in; and

the forwarding module 1014 is configured to forward the control request to the determined control server according to check-in time included in the check-in confirmation information.

The apparatus 1000 may further include a third receiving module 1018 stored in the memory 1004 and configured to receive a control result sent by the control server, the control result being used for representing a result of controlling the smart device by the controller according to the control instruction; and send the control result to the hotel management system to prompt the hotel management system the control result for the smart device.

In the 1990s, an improvement in a technology may be obviously distinguished as a hardware improvement (e.g., an improvement in circuit structures such as diodes, transistors, and switches) or a software improvement (an improvement in a method procedure). However, with the development of technologies, improvements of many method procedures at present may be considered as direct improvements in hardware circuit structures. Almost all designers program the improved method procedures into hardware circuits to obtain corresponding hardware circuit structures. Therefore, it is improper to say that the improvement of a method procedure cannot be implemented by using a hardware entity module. For example, a Programmable Logic Device (PLD) (e.g., a Field Programmable Gate Array (FPGA)) is an integrated circuit the logic functions of which are determined by a user through programming devices. Designers program by themselves to “integrate” a digital system into a PLD, without requiring a chip manufacturer to design and manufacture a dedicated integrated circuit chip. Moreover, at present, the programming is mostly implemented by using logic compiler software, instead of manually manufacturing an integrated circuit chip. The logic compiler software is similar to a software complier used for developing and writing a program, and to compile previous original codes, a specific programming language, which is referred to as a Hardware Description Language (HDL), is needed. There are many types of HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL), among which Very-High-Speed Integrated Circuit Hardware Description Language (VHDL) and Verilog are most commonly used now. Those skilled in the art should also know that a hardware circuit for implementing the logic method procedure may be easily obtained by simply logically programming the method procedure using the above several hardware description languages and programming it into an integrated circuit.

A controller may be implemented in any suitable manner. For example, the controller may employ a form of, for example, a microprocessor or a processor and a computer readable medium that stores computer readable program codes (such as software or firmware) executable by the (micro)processor or processor, a logic gate, a switch, an Application Specific Integrated Circuit (ASIC), a programmable logic controller and an embedded microcontroller. Examples of the controller include, but are not limited to, the following microcontrollers: ARC 625D, Atmel AT91SAM, Microchip PIC18F26K20 and Silicone Labs C8051F320. The controller of the memory may further be implemented as a part of control logic of the memory. Those skilled in the art also know that in addition to implementing the controller by using purely computer readable program codes, it is completely feasible to logically program the method steps to enable the controller to implement the same function in a form of a logic gate, a switch, an ASIC, a programmable logic controller and an embedded microcontroller. Therefore, such a controller may be considered as a hardware component, and apparatuses included in the controller and configured to implement various functions may also be considered as structures within the hardware component. Or, the apparatuses configured to implement various functions may even be considered as both software modules configured to implement the method and structures inside the hardware component.

The system, apparatus, modules or units illustrated in the foregoing example embodiments may be implemented by a computer chip or an entity, or by a product having a specific function. A typical implementation device is a computer. For example, the computer may be a personal computer, a laptop computer, a cellular phone, a camera phone, a smart phone, a personal digital assistant, a media player, a navigation device, an email device, a game console, a tablet computer, a wearable device, or a combination of any of these devices.

For ease of description, the above apparatus is described separately as various units divided by function. Certainly, in the implementation of the example embodiments of the present disclosure, functions of various units may also be implemented in one or more pieces of software and/or hardware.

Those skilled in the art should understand that the example embodiments of the present invention may be provided as a method, a system, or a computer program product. Therefore, the present invention may be implemented in a form of a complete hardware example embodiment, a complete software example embodiment, or an example embodiment combining software and hardware. Moreover, the present invention may be in the form of a computer program product implemented on one or more computer usable storage media (including, but not limited to, a magnetic disk memory, a CD-ROM, an optical memory and the like) including computer usable program codes.

The present invention is described with reference to flowcharts and/or block diagrams of the method, the device (system), and the computer program product according to the example embodiments of the present invention. It should be understood that each process and/or block in the flowcharts and/or block diagrams and combinations of processes and/or blocks in the flowcharts and/or block diagrams may be implemented by computer program instructions. The computer program instructions may be provided to a general-purpose computer, a special-purpose computer, an embedded processor or a processor of another programmable data processing device to generate a machine, such that the computer or the processor of another programmable data processing device executes an instruction to generate an apparatus configured to implement functions designated in one or more processes in a flowchart and/or one or more blocks in a block diagram.

The computer program instructions may also be stored in a computer readable storage that may guide the computer or another programmable data processing device to work in a specific manner, such that the instruction stored in the computer readable storage generates an article of manufacture including an instruction apparatus, and the instruction apparatus implements functions designated by one or more processes in a flowchart and/or one or more blocks in a block diagram.

The computer program instructions may also be loaded to the computer or another programmable data processing device, such that a series of operation steps are executed on the computer or another programmable device to generate a computer implemented processing, and therefore, the instruction executed in the computer or another programmable device provides steps for implementing functions designated in one or more processes in a flowchart and/or one or more blocks in a block diagram.

In a typical configuration, the computing device includes one or more central processing units (CPUs), an input/output interface, a network interface, and a memory.

The memory may include computer readable media such as a volatile memory, a Random-Access Memory (RAM), and/or non-volatile memory, e.g., a Read-Only Memory (ROM) or a flash RAM. The memory is an example of a computer readable medium.

The computer readable medium includes non-volatile and volatile media as well as movable and non-movable media, and may implement information storage by means of any method or technology. The information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

It should be further noted that the terms “include”, “comprise” or other variations thereof are intended to cover non-exclusive inclusion, so that a process, method, commodity or device including a series of elements not only includes the elements, but also includes other elements not clearly listed, or further includes elements inherent to the process, method, commodity or device. In the absence of more limitations, an element defined by “including a/an . . . ” does not exclude that the process, method, commodity or device including the element further has other identical elements.

Those skilled in the art should understand that the example embodiments of the present disclosure may be provided as a method, a system, or a computer program product. Therefore, the present disclosure may be implemented in a form of a complete hardware example embodiment, a complete software example embodiment, or an example embodiment combining software and hardware. Moreover, the present disclosure may be in the form of a computer program product implemented on one or more computer usable storage media (including, but not limited to, a magnetic disk memory, a CD-ROM, an optical memory and the like) including computer usable program codes.

The present disclosure may be described in a general context of a computer executable instruction executed by a computer, for example, a program module. Generally, the program module includes a routine, a program, an object, an assembly, a data structure, and the like used for executing a specific task or implementing a specific abstract data type. The present disclosure may also be implemented in distributed computing environments. In the distributed computing environments, a task is executed by using remote processing devices connected through a communications network. In the distributed computing environments, the program module may be located in local and remote computer storage media including a storage device.

Various example embodiments in the present specification are described progressively. The same or similar parts between the example embodiments may be referenced to one another. In each example embodiment, the part that is different from other example embodiments is mainly described. Particularly, the system example embodiment is described in a relatively simple manner because it is similar to the method example embodiment, and for related parts, reference may be made to the partial description in the method example embodiment.

The above description is merely example embodiments of the present disclosure, and is not used to limit the present disclosure. For those skilled in the art, the present disclosure may have various alterations and changes. Any modification, equivalent replacement, improvement and the like made without departing from the spirit and principle of the present disclosure should be included in the scope of the claims of the present disclosure.

The present disclosure may further be understood with clauses as follows.

Clause 1. A control method for a smart device, applied to a gateway platform, the method comprising:

receiving a control request sent by a client terminal, the control request carrying a device ID of a to-be-controlled smart device and first device execution information;

determining, according to the device ID, a control server corresponding to the device ID from control servers establishing a cooperative relationship with the gateway platform, wherein mapping relationships between device IDs of different smart devices and server IDs of control servers that control the different smart devices are stored in the gateway platform; and

forwarding the control request to the determined control server, so that the determined control server generates a control instruction according to the first device execution information and sends the control instruction to a controller corresponding to the device ID to cause the controller to control the smart device.

Clause 2. The control method according to clause 1, wherein the mapping relationships between device IDs of different smart devices and server IDs of control servers that control the different smart devices are established by:

receiving and storing server IDs of control servers of Internet of Things (IoT) service providers establishing a cooperative relationship with the gateway platform, controller IDs of controllers installed by the IoT service providers, and device IDs of smart devices;

for a respective device ID, determining a controller ID of a controller that controls a smart device corresponding to the respective device ID, and establishing a first correspondence between the respective device ID and the controller ID of the determined controller; and for a respective server ID, determining a controller ID of a controller installed by an IoT service provider corresponding to the respective server ID, and establishing a second correspondence between the respective server ID and the controller ID of the determined controller; and

obtaining, according to the first correspondence and the second correspondence, mapping relationships among the device IDs of different smart devices, the controller IDs of controllers that control the smart devices, and the server IDs of control servers that control the controllers of the smart devices.

Clause 3. The control method according to clause 2, the determining, according to the device ID, the control server corresponding to the device ID from the control servers establishing the cooperative relationship with the gateway platform specifically comprises:

determining, according to the mapping relationships among the device IDs of different smart devices, the controller IDs of controllers that control the smart devices, and the server IDs of control servers that control the controllers of the smart devices, a server ID corresponding to the device ID carried in the control request; and

determining a control server corresponding to the determined server ID as the control server corresponding to the device ID.

Clause 4. The control method according to clause 3, wherein the forwarding the control request to the determined control server specifically comprises:

encapsulating the control request according to a set gateway control protocol, and sending the encapsulated control request to the determined control server, so that the determined control server parses the encapsulated control request to obtain the device ID of the to-be-controlled device and the first device execution information, generates the control instruction according to the first device execution information, and sends the control instruction to the controller corresponding to the device ID to cause the controller to control the smart device.

Clause 5. The control method according to any of clauses 1 to 4, wherein:

the control request further carries a user ID of a user; and

after determining the control server corresponding to the device ID, the method further comprises:

searching, according to the user ID, a user behavior database for historical user behavior data corresponding to the user ID, the user behavior database comprising mapping relationships between user IDs and historical user behavior data;

generating second device execution information according to the device ID and the historical user behavior data; and

sending the second device execution information to the determined control server, so that the control server sends the second device execution information to the controller corresponding to the device ID to cause the controller to control the smart device according to the control instruction and the second device execution information.

Clause 6. The control method according to clause 5, wherein the generating the second device execution information according to the device ID and the historical user behavior data specifically comprises:

determining, according to the device ID, a device type of the smart device corresponding to the device ID;

determining, according to the device type, historical user behavior data related to the device type from the historical user behavior data corresponding to the user ID;

determining, according to the historical user behavior data, user behavior characteristics of the user corresponding to the user ID who controls the smart device; and

generating the second device execution information according to the user behavior characteristics.

Clause 7. The control method according to clause 6, wherein the user behavior database is obtained specifically by:

for different user IDs, collecting device execution data and/or user service data sent through the user IDs, determining the collected device execution data and/or user service data as the historical user behavior data, and storing the user IDs and the historical user behavior data into the user behavior database.

Clause 8. A control method for a smart device, applied to a gateway platform, the method comprising:

receiving control information input by a user, the control information comprising a device ID of a to-be-controlled smart device and first device execution information;

generating, according to the control information, a control request carrying the control information; and

sending the control request to the gateway platform, so that the gateway platform determines, according to the device ID, a control server corresponding to the device ID from control servers establishing a cooperative relationship with the gateway platform, and forwards the control request to the determined control server to cause the determined control server to generate a control instruction and send the control instruction to a corresponding controller to control the corresponding smart device.

Clause 9. The control method according to clause 8, wherein the generating, according to the control information, a control request carrying the control information specifically comprises:

generating, according to the control information, a control request carrying the control information and a user ID of the user, so that the gateway platform receiving the control request searches, according to the user ID, a user behavior database for historical user behavior data corresponding to the user ID and then controls the corresponding smart device according to the historical user behavior data.

Clause 10. A control method for a smart device, applied to a gateway platform, the method comprising:

receiving a control request sent by a user, the control request carrying a room ID allocated to the user, a device ID of a to-be-controlled smart device, and first device execution information;

determining, according to the room ID and a user ID of the user, a control permission of the user to control a smart device in a room corresponding to the room ID;

determining, according to the device ID, a control server corresponding to the device ID from control servers establishing a cooperative relationship with the gateway platform when the determined control permission allows control over the to-be-controlled smart device; and

forwarding the control request to the determined control server, so that the determined control server generates a control instruction according to the first device execution information and sends the control instruction to a controller corresponding to the device ID to cause the controller to control the smart device.

Clause 11. The control method according to clause 10, wherein the method further comprises:

sending a prompt message to remind the user of a control failure when the determined control permission refuses the control over the to-be-controlled smart device.

Clause 12. The control method according to clause 10 or 11, wherein before receiving the control request sent by the user, the method further comprises:

receiving check-in information sent by a hotel management system, wherein the check-in information is generated by the hotel management system after confirmation information about user's check-in is received, and the check-in information comprises a room ID allocated by the hotel management system to the user and check-in time; and

determining, according to the check-in time, a control permission of the user to control a smart device in a room corresponding to the room ID, and establishing a mapping relationship among the user ID, the room ID, and the control permission.

Clause 13. The control method according to clause 10 or 11, wherein the method further comprises:

receiving order data sent by the user, the order data comprising a hotel ID selected by the user;

sending the order data to a hotel management system corresponding to the hotel ID, so that the hotel management system allocates a check-in room to the user according to the order data;

receiving response data sent by the hotel management system, the response data comprising a room ID of the room allocated to the user and the hotel ID; and

establishing a mapping relationship among the user ID, the hotel ID, and the room ID.

Clause 14. The control method according to clause 13, wherein when the response data sent by the hotel management system is received, the method further comprises:

allocating, according to check-in time, included in the order data, when the user checks in a hotel corresponding to the hotel ID, to the user a control permission of the user to control a smart device in the room corresponding to the room ID.

Clause 15. The control method according to clause 13 or 14, wherein the method further comprises:

receiving check-in confirmation information sent by the hotel system, the check-in confirmation information being generated by the hotel management system after the user checks in; and

granting the control permission of the user to control the smart device in the room corresponding to the room ID when the check-in confirmation information is received.

Clause 16. The control method according to clause 10, wherein after determining the control server corresponding to the device ID, the method further comprises:

searching, according to the user ID, a user behavior database for historical user behavior data corresponding to the user ID, the user behavior database storing mapping relationships between user IDs and historical user behavior data; and

generating second device execution information according to the device ID and the historical user behavior data; and

the forwarding the control request to the determined control server comprises:

sending the control request and the second device execution information together to the determined control server, so that the control server generates a control instruction according to the second device execution information and the first device execution information in the control request and sends the control instruction to the controller corresponding to the device ID to cause the controller to control the smart device.

Clause 17. A control method for a smart device comprising:

receiving check-in confirmation information sent by a hotel management system, wherein the check-in confirmation information is generated by the hotel management system after a user checks in, and the check-in information comprises a room ID allocated by the hotel management system to the user;

acquiring, according to the check-in confirmation information, a control page for the user to control a smart device in a room corresponding to the room ID; and

sending, based on the control page, a control request to a network platform, wherein the control request carries the room ID allocated to the user, a device ID of a to-be-controlled smart device, and first device execution information, so that the network platform controls the to-be-controlled smart device according to the control request.

Clause 18. The control method according to clause 17, wherein the method further comprises:

determining, according to the check-in confirmation information, a control permission of the user to control the smart device in the room corresponding to the room ID; and

displaying the control permission in the control page.

Clause 19. A control method for a smart device, the method comprising:

receiving a control request sent by a hotel management system, the control request carrying a device ID of a to-be-controlled smart device and first device execution information;

determining, according to the device ID, a control server corresponding to the device ID from control servers establishing a cooperative relationship with the gateway platform; and

forwarding the control request to the determined control server, so that the determined control server generates a control instruction according to the first device execution information and sends the control instruction to a controller corresponding to the device ID to cause the controller to control the smart device.

Clause 20. The control method according to clause 19, wherein:

the control request further carries sending time of the control instruction; and

the forwarding the control request to the determined control server comprises forwarding the control request to the determined control server according to the sending time.

Clause 21. The control method according to clause 19, wherein:

before receiving the control request sent by the hotel management system, the method further comprises receiving check-in confirmation information sent by the hotel system, wherein the check-in confirmation information is generated by the hotel management system after a user checks in; and

the forwarding the control request to the determined control server comprises forwarding the control request to the determined control server according to check-in time comprised in the check-in confirmation information.

Clause 22. The control method according to clause 19, wherein the method further comprises:

receiving a control result sent by the control server, the control result being used for representing a result of controlling the smart device by the controller according to the control instruction; and

sending the control result to the hotel management system to prompt the hotel management system the control result for the smart device.

Clause 23. A control apparatus for a smart device, comprising:

a receiving module configured to receive a control request sent by a client terminal, wherein a device ID of a to-be-controlled smart device and first device execution information are carried in the control request;

a determining module configured to determine, according to the device ID, a control server corresponding to the device ID from control servers establishing a cooperative relationship with the control apparatus, wherein mapping relationships between device IDs of different smart devices and server IDs of control servers that control the smart devices are stored in the control apparatus; and

a forwarding module configured to forward the control request to the determined control server, so that the determined control server generates a control instruction according to the first device execution information and sends the control instruction to a controller corresponding to the device ID to cause the controller to control the smart device.

Clause 24. The control apparatus according to clause 23, wherein the mapping relationships between device IDs of different smart devices and server IDs of control servers that control the smart devices are established by:

receiving and storing server IDs of control servers of IoT service providers establishing a cooperative relationship with the control apparatus, controller IDs of controllers installed by the IoT service providers, and device IDs of smart devices;

for each device ID, determining a controller ID of a controller that controls a smart device corresponding to the device ID, and establishing a first correspondence between the device ID and the controller ID of the determined controller; and for each server ID, determining a controller ID of a controller installed by an IoT service provider corresponding to the server ID, and establishing a second correspondence between the server ID and the controller ID of the determined controller; and

obtaining, according to the first correspondence and the second correspondence, mapping relationships among the device IDs of different smart devices, the controller IDs of controllers that control the smart devices, and the server IDs of control servers that control the controllers of the smart devices.

Clause 25. The control apparatus according to clause 24, wherein the determining module is configured to determine, according to the mapping relationships among the device IDs of different smart devices, the controller IDs of controllers that control the smart devices, and the server IDs of control servers that control the controllers of the smart devices, a server ID corresponding to the device ID carried in the control request; and determine a control server corresponding to the determined server ID as the control server corresponding to the device ID.

Clause 26. The control apparatus according to clause 25, wherein the forwarding module is configured to encapsulate the control request according to a set gateway control protocol, and send the encapsulated control request to the determined control server, so that the determined control server parses the encapsulated control request to obtain a to-be-controlled device ID and the first device execution information, generates a control instruction according to the first device execution information, and sends the control instruction to the controller corresponding to the device ID to cause the controller to control the smart device.

Clause 27. The control apparatus according to any of clauses 23 to 26, wherein a user ID of a user is further carried in the control request; and

the apparatus further comprises: a searching module configured to search, according to the user ID after the control server corresponding to the device ID is determined, a user behavior database for historical user behavior data corresponding to the user ID, the user behavior database comprising mapping relationships between user IDs and historical user behavior data; generate second device execution information according to the device ID and the historical user behavior data; and send the second device execution information to the determined control server, so that the control server sends the second device execution information to the controller corresponding to the device ID and the controller to control the smart device according to the control instruction and the second device execution information.

Clause 28. The control apparatus according to clause 27, wherein the searching module is configured to determine, according to the device ID, a device type of the smart device corresponding to the device ID; determine, according to the device type, historical user behavior data related to the device type from the historical user behavior data corresponding to the user ID; determine, according to the historical user behavior data, user behavior characteristics of the user corresponding to the user ID who controls the smart device; and generate the second device execution information according to the user behavior characteristics.

Clause 29. The control apparatus according to clause 28, wherein the user behavior database is obtained specifically by:

for different user IDs, collecting device execution data and/or user service data sent through the user IDs, determining the collected device execution data and/or user service data as historical user behavior data, and storing the user IDs and the historical user behavior data into the user behavior database.

Clause 30. A control apparatus for a smart device, applied to a gateway platform, the apparatus comprising:

a receiving module configured to receive control information input by a user, the control information comprising a device ID of a to-be-controlled smart device and first device execution information;

a generating module configured to generate, according to the control information, a control request carrying the control information; and

a sending module configured to send the control request to the gateway platform, so that the gateway platform determines, according to the device ID, a control server corresponding to the device ID from control servers establishing a cooperative relationship with the gateway platform, and forwards the control request to the determined control server to cause the determined control server to generate a control instruction and send the control instruction to a corresponding controller to control the corresponding smart device.

Clause 31. The control apparatus according to clause 30, wherein the generating module is configured to generate, according to the control information, a control request carrying the control information and a user ID of the user, so that the gateway platform receiving the control request searches, according to the user ID, a user behavior database for historical user behavior data corresponding to the user ID and then controls the corresponding smart device according to the historical user behavior data.

Clause 32. A control apparatus for a smart device, the apparatus comprising:

a first receiving module configured to receive a control request sent by a user, wherein a room ID allocated to the user, a device ID of a to-be-controlled smart device, and first device execution information are carried in the control request;

a first determining module configured to determine, according to the room ID and a user ID of the user, a control permission of the user to control a smart device in a room corresponding to the room ID;

a second determining module configured to determine, according to the device ID, a control server corresponding to the device ID from control servers establishing a cooperative relationship with the control apparatus when the determined control permission allows control over the to-be-controlled smart device; and

a forwarding module configured to forward the control request to the determined control server, so that the determined control server generates a control instruction according to the first device execution information and sends the control instruction to a controller corresponding to the device ID to cause the controller to control the smart device.

Clause 33. The control apparatus according to clause 32, wherein the apparatus further comprises:

a sending module configured to send a prompt message to remind the user of a control failure when the determined control permission refuses the control over the to-be-controlled smart device.

Clause 34. The control apparatus according to clause 32 or 33, wherein the apparatus further comprises: a second receiving module configured to receive check-in information sent by a hotel management system before the control request sent by the user is received, wherein the check-in information is generated by the hotel management system after confirmation information about user's check-in is received, and comprises a room ID allocated by the hotel management system to the user and check-in time; and determine, according to the check-in time, a control permission of the user to control a smart device in a room corresponding to the room ID, and establish a mapping relationship among the user ID, the room ID, and the control permission.

Clause 35. The control apparatus according to clause 32 or 33, wherein the apparatus further comprises: a third receiving module configured to receive order data sent by the user, the order data comprising a hotel ID selected by the user; send the order data to a hotel management system corresponding to the hotel ID, so that the hotel management system allocates a check-in room to the user according to the order data; receive response data sent by the hotel management system, the response data comprising a room ID of the room allocated to the user and the hotel ID; and establish a mapping relationship among the user ID, the hotel ID, and the room ID.

Clause 36. The control apparatus according to clause 35, wherein the apparatus further comprises: an allocating module configured to, when the response data sent by the hotel management system is received, allocate, according to check-in time comprised in the order data and indicating the time when the user checks in a hotel corresponding to the hotel ID, to the user a control permission of the user to control a smart device in the room corresponding to the room ID.

Clause 37. The control apparatus according to clause 35 or 36, wherein the apparatus further comprises: a fourth receiving module configured to receive check-in confirmation information sent by the hotel system, the check-in confirmation information being generated by the hotel management system after the user checks in; and grant the control permission of the user to control the smart device in the room corresponding to the room ID when the check-in confirmation information is received.

Clause 38. The control apparatus according to clause 32, wherein the apparatus further comprises: a searching module configured to search, according to the user ID after the control server corresponding to the device ID is determined, a user behavior database for historical user behavior data corresponding to the user ID, the user behavior database comprising mapping relationships between user IDs and historical user behavior data; and generate second device execution information according to the device ID and the historical user behavior data; and

the forwarding module is configured to send the control request and the second device execution information together to the determined control server, so that the control server generates a control instruction according to the second device execution information and the first device execution information in the control request and sends the control instruction to the controller corresponding to the device ID to cause the controller to control the smart device.

Clause 39. A control apparatus for a smart device, comprising:

a receiving module configured to receive check-in confirmation information sent by a hotel management system, wherein the check-in confirmation information is generated by the hotel management system after a user checks in, and comprises a room ID allocated by the hotel management system to the user;

an acquiring module configured to acquire, according to the check-in confirmation information, a control page for the user to control a smart device in a room corresponding to the room ID; and

a sending module configured to send, based on the control page, a control request to a network platform, wherein the room ID allocated to the user, a device ID of a to-be-controlled smart device, and first device execution information are carried in the control request, so that the network platform controls the to-be-controlled smart device according to the control request.

Clause 40. The control apparatus according to clause 39, wherein the apparatus further comprises:

a display module configured to determine, according to the check-in confirmation information, a control permission of the user to control the smart device in the room corresponding to the room ID; and display the control permission in the control page.

Clause 41. A control apparatus for a smart device, comprising:

a first receiving module configured to receive a control request sent by a hotel management system, wherein a device ID of a to-be-controlled smart device and first device execution information are carried in the control request;

a determining module configured to determine, according to the device ID, a control server corresponding to the device ID from control servers establishing a cooperative relationship with the gateway platform; and

a forwarding module configured to forward the control request to the determined control server, so that the determined control server generates a control instruction according to the first device execution information and sends the control instruction to a controller corresponding to the device ID to cause the controller to control the smart device.

Clause 42. The control apparatus according to clause 41, wherein sending time of the control instruction is further carried in the control request; and

the forwarding module is configured to forward the control request to the determined control server according to the sending time.

Clause 43. The control apparatus according to clause 41, wherein the apparatus further comprises: a second receiving module configured to, before the control request sent by the hotel management system is received, receive check-in confirmation information sent by the hotel system, wherein the check-in confirmation information is generated by the hotel management system after a user checks in; and

the forwarding module is configured to forward the control request to the determined control server according to check-in time comprised in the check-in confirmation information.

Clause 44. The control apparatus according to clause 41, wherein the apparatus further comprises: a third receiving module configured to receive a control result sent by the control server, the control result being used for representing a result of controlling the smart device by the controller according to the control instruction; and send the control result to the hotel management system to prompt the hotel management system the control result for the smart device

What is claimed is:

1. A method comprising:
receiving a control request sent by a client terminal, the control request carrying a device ID of a to-be-controlled smart device and first device execution information;
determining, according to the device ID, a control server corresponding to the device ID from control servers establishing a cooperative relationship with a gateway platform, wherein the gateway platform stores mapping relationships between device IDs of different smart devices and server IDs of control servers that control the different smart devices; and
forwarding the control request to the determined control server.

2. The method of claim 1, wherein the forwarding the control request to the determined control server includes:
forwarding the control request to the determined control server to request the determined control server to generate a control instruction according to the first device execution information and to send the control instruction to a controller corresponding to the device ID to cause the controller to control the smart device.

3. The method of claim 1, further comprising establishing the mapping relationships between the device IDs of different smart devices and the server IDs of control servers.

4. The method of claim 3, wherein the establishing the mapping relationships includes:
storing server IDs of control servers of Internet of Things (IoT) service providers establishing a cooperative relationship with the gateway platform, controller IDs of controllers installed by the IoT service providers, and device IDs of smart devices;
for a respective device ID, determining a controller ID of a controller that controls a smart device corresponding to the respective device ID, and establishing a first correspondence between the respective device ID and the controller ID of the determined controller;
for a respective server ID, determining a controller ID of a controller installed by an IoT service provider corresponding to the respective server ID, and establishing a second correspondence between the respective server ID and the controller ID of the determined controller; and
obtaining, according to the first correspondence and the second correspondence, the mapping relationships among the device IDs of different smart devices, the controller IDs of controllers that control the smart devices, and the server IDs of control servers that control the controllers of the smart devices.

5. The method of claim 1, further comprising determining, according to the device ID, the control server corresponding to the respective device ID from the control servers establishing the cooperative relationship with the gateway platform.

6. The method of claim 5, wherein the determining, according to the device ID, the control server corresponding to the respective device ID from the control servers establishing the cooperative relationship with the gateway platform includes:
determining, according to the mapping relationships among the device IDs of different smart devices, the controller IDs of controllers that control the smart devices, and the server IDs of control servers that control the controllers of the smart devices, a server ID corresponding to the device ID carried in the control request; and
determining the control server corresponding to the determined server ID as the control server corresponding to the device ID.

7. The method of claim 1, wherein the forwarding the control request to the determined control server includes:
encapsulating the control request according to a set gateway control protocol; and
sending the encapsulated control request to the determined control server.

8. The method of claim 7, wherein the sending the encapsulated control request to the determined control server includes:
sending the encapsulated control request to the determined control server to request the determined control server to parse the encapsulated control request to obtain the device ID of the to-be-controlled device and the first device execution information, to generate the control instruction according to the first device execution information, and to send the control instruction to the controller corresponding to the device ID to cause the controller to control the smart device.

9. The method of claim 1, wherein the control request further carries a user ID of a user.

10. The method of claim 9, further comprising:
after determining the control server corresponding to the device ID,
searching, according to the user ID, a user behavior database for historical user behavior data corresponding to the user ID, the user behavior database comprising mapping relationships between user IDs and historical user behavior data;
generating second device execution information according to the device ID and the historical user behavior data; and
sending the second device execution information to the determined control server, so that the control server sends the second device execution information to the controller corresponding to the device ID to cause the controller to control the smart device according to the control instruction and the second device execution information.

11. The method of claim 10, wherein the generating the second device execution information according to the device ID and the historical user behavior data includes:
determining, according to the device ID, a device type of the smart device corresponding to the device ID;
determining, according to the device type, historical user behavior data related to the device type from the historical user behavior data corresponding to the user ID;
determining, according to the historical user behavior data, user behavior characteristics of the user corresponding to the user ID who controls the smart device; and
generating the second device execution information according to the user behavior characteristics.

12. The method of claim 11, further comprising obtaining the user behavior database, the obtaining the user behavior data includes:
for different user IDs, collecting device execution data or user service data sent through the user IDs;
determining the collected device execution data or user service data as the historical user behavior data; and
storing the user IDs and the historical user behavior data into the user behavior database.

13. An apparatus comprising:
one or more processors; and
one or more memories stored thereon computer readable instructions that, when executed by the one or more processors, cause the one or more processors to perform acts comprising:
receiving a control request sent by a user, the control request carrying a room ID allocated to the user, a device ID of a to-be-controlled smart device, and first device execution information;
determining, according to the room ID and a user ID of the user, a control permission of the user to control a smart device in a room corresponding to the room ID;
determining, according to the device ID, a control server corresponding to the device ID from control servers establishing a cooperative relationship with the gateway platform when the determined control permission allows control over the to-be-controlled smart device; and
forwarding the control request to the determined control server, so that the determined control server generates a control instruction according to the first device execution information and sends the control instruction to a controller corresponding to the device ID to cause the controller to control the smart device.

14. The apparatus of claim 13, wherein the acts further comprise:
sending a prompt message to remind the user of a control failure when the determined control permission refuses the control over the to-be-controlled smart device.

15. The apparatus of claim 13, wherein, before receiving the control request sent by the user, the acts further comprise:
receiving check-in information sent by a hotel management system, wherein the check-in information is generated by the hotel management system after confirmation information about user's check-in is received, and the check-in information comprises a room ID allocated by the hotel management system to the user and check-in time; and
determining, according to the check-in time, a control permission of the user to control a smart device in a room corresponding to the room ID, and establishing a mapping relationship among the user ID, the room ID, and the control permission.

16. The apparatus of claim 13, wherein the acts further comprise:
receiving order data sent by the user, the order data comprising a hotel ID selected by the user;
sending the order data to a hotel management system corresponding to the hotel ID so that the hotel management system allocates a check-in room to the user according to the order data;
receiving response data sent by the hotel management system, the response data comprising a room ID of the room allocated to the user and the hotel ID; and
establishing a mapping relationship among the user ID, the hotel ID, and the room ID.

17. The apparatus of claim 16, wherein the acts further comprise:
allocating, according to check-in time, included in the order data, when the user checks in a hotel corresponding to the hotel ID, to the user a control permission of the user to control a smart device in the room corresponding to the room ID.

18. The apparatus of claim 16, wherein the acts further comprise:
receiving check-in confirmation information sent by the hotel system, the check-in confirmation information being generated by the hotel management system after the user checks in; and
granting the control permission of the user to control the smart device in the room corresponding to the room ID when the check-in confirmation information is received.

19. The apparatus of claim 13, wherein after determining the control server corresponding to the device ID, the acts further comprise:
searching, according to the user ID, a user behavior database for historical user behavior data corresponding to the user ID, the user behavior database storing mapping relationships between user IDs and historical user behavior data; and
generating second device execution information according to the device ID and the historical user behavior data; and
the forwarding the control request to the determined control server includes:
sending the control request and the second device execution information together to the determined control server to request the control server to generate a control instruction according to the second device execution information and the first device execution information in the control request and to send the control instruction to the controller corresponding to the device ID to cause the controller to control the smart device.

20. One or more memories stored thereon computer readable instructions that, when executed by one or more processors, cause the one or more processors to perform acts comprising:
receiving a control request sent by a hotel management system, the control request carrying a device ID of a to-be-controlled smart device and first device execution information;
determining, according to the device ID, a control server corresponding to the device ID from control servers establishing a cooperative relationship with the gateway platform; and
forwarding the control request to the determined control server to request the determined control server to generate a control instruction according to the first device execution information and to send the control instruction to a controller corresponding to the device ID to cause the controller to control the smart device.
